(19) United States
(12) Patent Application Publication
(10) Pub. No.: US 2008/0221965 A1
(43) Pub. Date: Sep. 11, 2008

(54) SYSTEM AND METHOD FOR DISASTER TRAINING, SIMULATION, AND RESPONSE

(76) Inventor: Chris Riddle, Franklin, TN (US)

Correspondence Address: W. EDWARD RAMAGE, COMMERCE CENTER SUITE 1000, 211 COMMERCE ST, NASHVILLE, TN, 37201, US

(21) Appl. No.: 12/029,242

(22) Filed: Feb. 11, 2008

Related U.S. Application Data
(60) Provisional application No. 60/889,081, filed on Feb. 9, 2007.

(51) Int. Cl. G06Q 10/00

(52) U.S. Cl. 705/9

(57) ABSTRACT

A system for conducting simulations of disaster and hazardous incident responses to assist in the organization, planning, and testing of the response of healthcare and other institutions to such incidents. A series of modules are used to enter personnel resource information into the system, design and create disaster and hazardous incident scenarios, assign personnel to incident command system (ICS) roles, and conduct a simulation with said personnel taking appropriate responsive actions. Personnel may interface with the system through a program creating a dashboard interface. Personnel can access an ICS organization chart, and use it to initiate messages and communications, conduct meetings, take actions, and assign subordinate positions. Personnel can view the status of the response actions in real-time. Standard and custom reports can be created and viewed. The system also can be used to respond to a real incident using the same interface and methods practiced in the simulation.

This application claims benefit of, and priority to, U.S. Provisional Patent Application No. 60/889,081, filed Feb. 9, 2007, entitled “SYSTEM AND METHOD FOR DISASTER TRAINING, SIMULATION, AND RESPONSE,” and is entitled, in whole or in part, to that filing date. The complete specification, drawings, attachments and disclosure of U.S. Provisional Patent Application No. 60/889,081 are incorporated herein by specific reference.

### FIELD OF INVENTION

The present invention comprises a system and method for conducting on-line simulations of a variety of disaster scenarios for training and testing of personnel. The invention may also be used for actual responses to disaster events.

### BACKGROUND OF THE INVENTION

Organizations of various sorts need to conduct regular exercises in order to train and prepare for responding to disasters. At present, however, there is no practical way for organizations to conduct regular exercises to plan a disaster incident management framework, create an organization and allocate personnel to necessary roles, as well as plan the step-by-step actions to be exercised by concerned individuals.

Accordingly, what is needed is a way to plan and conduct such exercises, and respond to such incidents, and prepare and submit reports to the appropriate regulatory authorities or governing bodies.

### SUMMARY OF THE INVENTION

A system for conducting simulations of disaster and hazardous incident responses to assist in the organization, planning, and testing of the response of healthcare and other institutions to such incidents. In one exemplary embodiment, the system comprises a series of modules to enter personnel resource information into the system, design and create disaster and hazardous incident scenarios, assign personnel to incident command system (ICS) roles, and conduct a simulation with said personnel taking appropriate responsive actions.

In one embodiment, personnel interface with the system through a program creating a dashboard interface. Personnel can access an ICS organization chart, and use it to initiate messages and communications, conduct meetings, take actions, and assign subordinate positions. These actions also can be taken directly. Personnel can view the status of the response actions in real-time. Standard and custom reports can be created and viewed.

In another embodiment, the system can be used to respond to a real incident using the same interface and methods practiced in the simulation.

### DESCRIPTION OF THE DRAWINGS

FIG. 1 shows a view of a login screen in accordance with one exemplary embodiment of the present invention.

FIG. 2 shows an alternative view of a login screen in accordance with another exemplary embodiment of the present invention.

FIG. 3 shows a web page with login information in accordance with another exemplary embodiment of the present invention.

FIG. 4 shows a system welcome page in accordance with another exemplary embodiment of the present invention.

FIG. 5 shows a view of a structure options main screen in accordance with an exemplary embodiment of the present invention.

FIG. 6 shows a view of a screen to add a new ICS position in accordance with an exemplary embodiment of the present invention.

FIG. 7 shows a view of a structure options tasks screen in accordance with an exemplary embodiment of the present invention.

FIG. 8 shows a view of a resources page in accordance with an exemplary embodiment of the present invention.

FIG. 9 shows an alternative view of a resources page in accordance with an exemplary embodiment of the present invention.

FIG. 10 shows a view of an add new resources page in accordance with an exemplary embodiment of the present invention.

FIG. 11 shows an alternative view of an add new resources page in accordance with an exemplary embodiment of the present invention.

FIG. 12 shows a view of an add communications device page in accordance with an exemplary embodiment of the present invention.

FIG. 13 shows an alternative view of an add communications device page in accordance with an exemplary embodiment of the present invention.

FIG. 14 shows a resource input screen for a phone in accordance with an exemplary embodiment of the present invention.

FIG. 15 shows a resource input screen for email in accordance with an exemplary embodiment of the present invention.

FIG. 16 shows resource input screens for a fax and pager in accordance with an exemplary embodiment of the present invention.

FIG. 17 shows a view of a scenario options summary screen in accordance with an exemplary embodiment of the present invention.

FIG. 18 shows an add new scenario input page in accordance with an exemplary embodiment of the present invention.

FIG. 19 shows a manage scenario messages screen in accordance with an exemplary embodiment of the present invention.

FIG. 20 shows a new message input screen in accordance with an exemplary embodiment of the present invention.

FIG. 21 shows an ICS organization chart screen in accordance with an exemplary embodiment of the present invention.

FIG. 22 shows a view of a reports main page in accordance with an exemplary embodiment of the present invention.

FIG. 23 shows an alternative view of a reports main page in accordance with an exemplary embodiment of the present invention.

FIG. 24 shows a view of a settings page in accordance with an exemplary embodiment of the present invention.

FIG. 25 shows an alternative view of a settings page in accordance with an exemplary embodiment of the present invention.

FIG. 26 shows a view of a simulation summary page in accordance with an exemplary embodiment of the present invention.

FIG. 27 shows an alternative view of a simulation summary page in accordance with an exemplary embodiment of the present invention.

FIG. 28 shows a view of a simulation resource selection page in accordance with an exemplary embodiment of the present invention.

FIG. 29 shows an add new exercise screen in accordance with an exemplary embodiment of the present invention.

FIG. 30 show an interjection summary screen in accordance with an exemplary embodiment of the present invention.

FIGS. 31 and 32 show screens for adding new interjections in accordance with an exemplary embodiment of the present invention.

FIG. 33 shows a conduct exercise main screen in accordance with an exemplary embodiment of the present invention.

FIG. 34 shows an exercise resource selection screen in accordance with an exemplary embodiment of the present invention.

FIG. 35 shows an exercise scheduling screen in accordance with an exemplary embodiment of the present invention.

FIG. 36 shows a view of an Incident Response Guide screen in accordance with one exemplary embodiment of the present invention.

FIG. 37 shows a view of an Incident Briefing screen in accordance with one exemplary embodiment of the present invention.

FIG. 38 shows a view of an Incident Briefing form in accordance with one exemplary embodiment of the present invention.

FIG. 39 shows a view of an Activate Command Staff screen in accordance with one exemplary embodiment of the present invention.

FIG. 40 shows a view of an Organizational Chart screen in accordance with one exemplary embodiment of the present invention.

FIG. 41 shows a view of a Meeting Module screen in accordance with one exemplary embodiment of the present invention.

FIG. 42 shows a view of an Incident Message form in accordance with one exemplary embodiment of the present invention.

FIG. 43 shows an Organizational Chart listing positions in accordance with one exemplary embodiment of the present invention.

FIG. 44 shows an exercise log-in screen in accordance with an exemplary embodiment of the present invention.

FIG. 45 shows an exercise controller dashboard screen in accordance with an exemplary embodiment of the present invention.

FIG. 46 shows a participant dashboard screen in accordance with an exemplary embodiment of the present invention.

FIG. 47 shows a incident management screen in accordance with an exemplary embodiment of the present invention.

FIGS. 48 through 54 show views of a position control control panel/dashboard in accordance with an exemplary embodiment of the present invention.

### DETAILED DESCRIPTION OF THE INVENTION

The present invention and system allows healthcare and other organizations, such as schools, municipalities, and governmental agencies, to conduct simulated disaster scenarios testing their ability to respond to hazards or disasters that could affect the safety of human lives or impact operations. Current “tabletop” training requires personnel to be located in the same room and work with paper forms. The simulations of the present invention are conducted on the Internet or over a network, allowing individuals to train and participate from a variety of locations, thus greatly facilitating and lower the cost and burden of training.

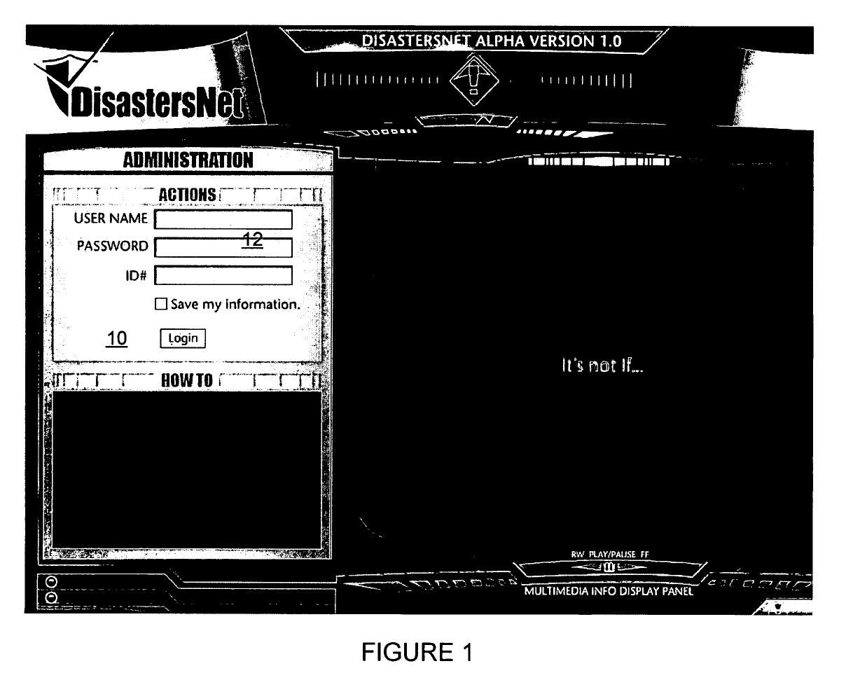

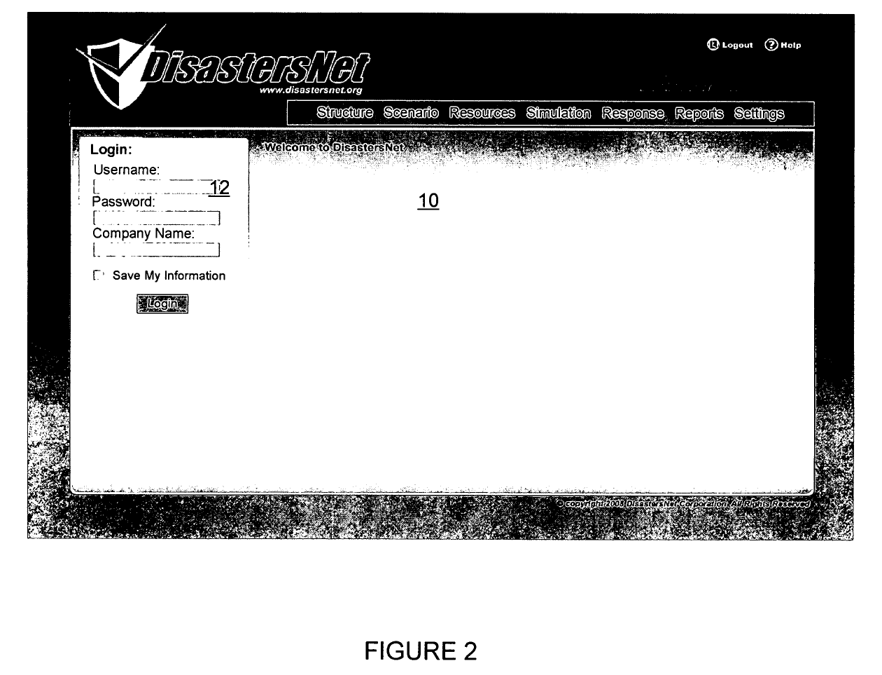

FIGS. 1 and 2 show alternative embodiments of a login screen 10 in accordance with one exemplary embodiment of the present invention. The login screen can be reached in a variety of ways, such as by going to a web page that initiates the program, or initiating the program on a computer. The login screen 10 prompts the individual to enter identification information. This identification information may be a username and password 12. In an alternative embodiment, the user may be prompted to enter a user identification number instead of or in addition to one or more of the above.

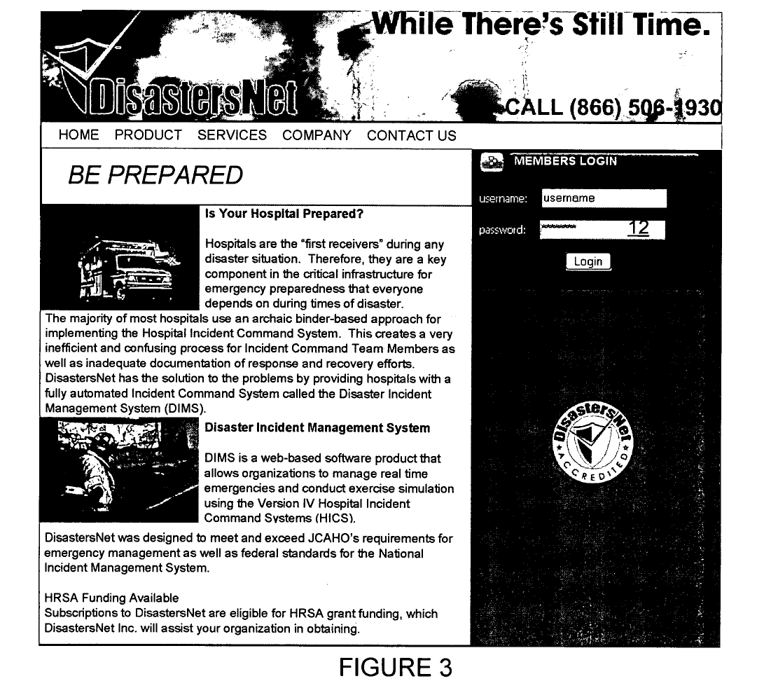

The login screen 10 can be a standalone screen with just the login requests, or as seen in FIGS. 1 and 2, or may appear as a component in a larger image or console, which may exhibit or play a visual or audible display, or both, during the process. FIG. 3 shows a web page with login information 12.

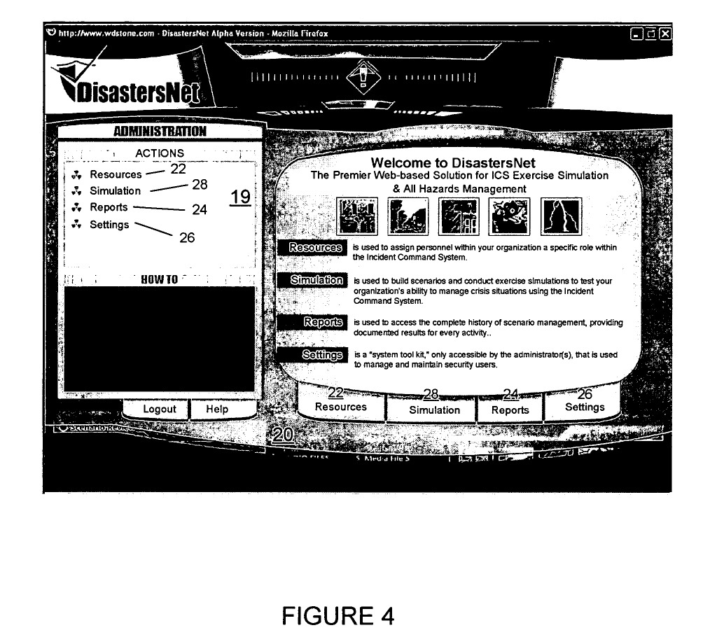

After logging in, the user may implement various functions of the system. In one exemplary embodiment, as shown in FIG. 4, the user may be taken to a “welcome” page or screen 20. The welcome page may present several options 19 to the user. The presentation of options may be in the form of menus, buttons, tabs, or the like. FIG. 4 shows four options that the user can select by means of tabs extending from a box containing a text description of the options. FIG. 4 shows four options-Resources 22, Simulations 28, Reports 24, Settings 26—although there may be more or fewer options in alternative embodiments of the system. As shown in FIG. 2, for example, the user has seven options presented as tabs along the top of the page: Structure 21, Scenario 23, Resources 22, Simulation 28, Response 25, Reports 24, Settings 26.

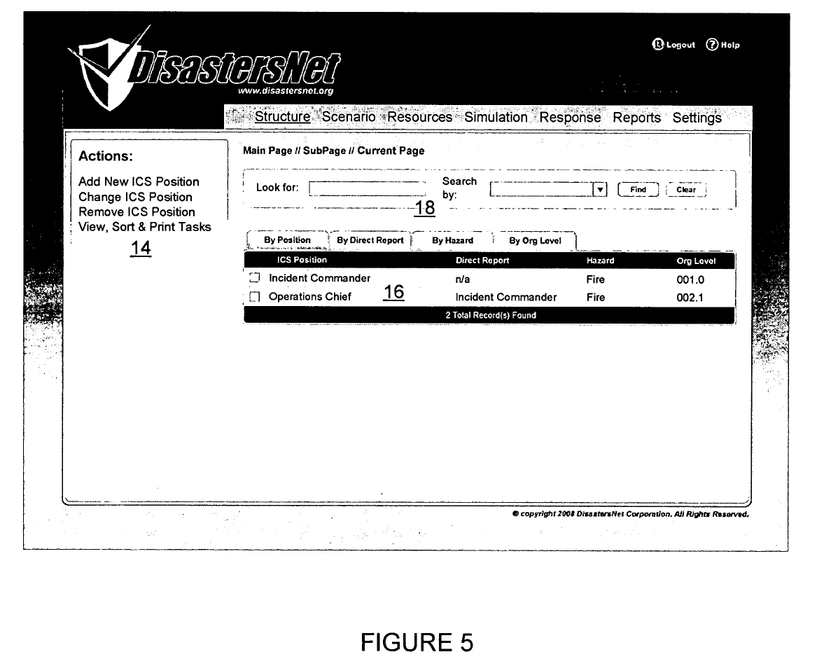

The Structure option 21 permits the user to add, change and remove Incident Command System (ICS) positions, and view, sort and print tasks. FIG. 5 shows an exemplary embodiment of a structure options main or summary screen, which has action selections 14 on the left side of the screen and a resources list or table 16 on the right side. The resources table 16 can be ordered in a variety of ways: in the embodiment shown, these include by position, by direct report responsibility, by hazard, and by organization level. The ability to look or search for particular information or entries also may be provided 18. These components may be located elsewhere in other configurations.

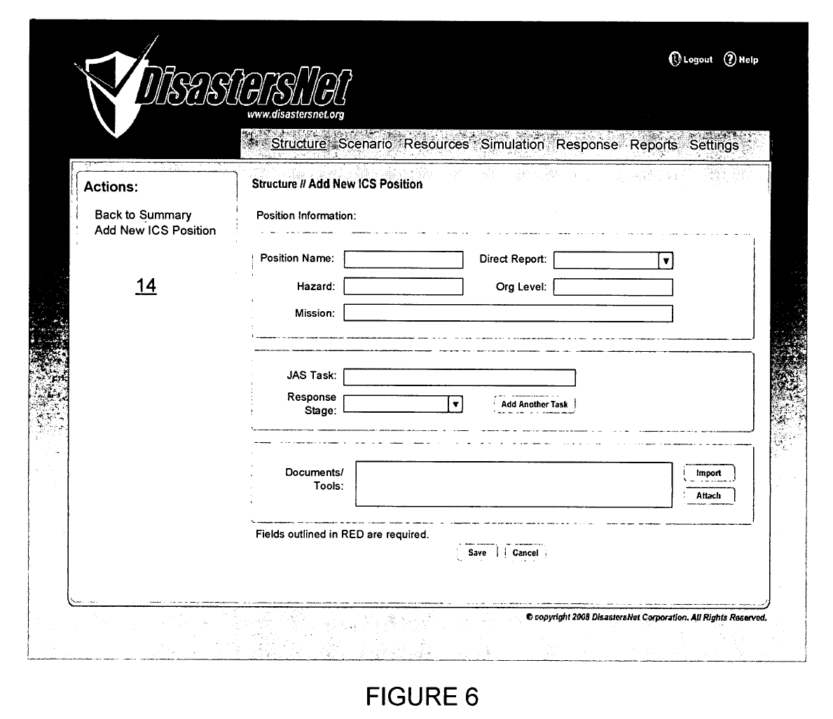

FIG. 6 shows an embodiment of a screen for adding a new ICS position under the structure option. In this embodiment, the information to be input includes position name, positions to which the new position has direct report obligations (as shown, a pull-down menu may be provided to supply existing positions already entered in the system), type of hazard, organization level, mission, JAS tasks (multiple tasks may be entered), response stage (as shown, a pull-down menu providing options may be used), and documents and tools (which may be imported and attached). Some or all of the entries may be required (in this embodiment, required fields are outlined in red), and some or all of the entry fields may be provided with means for providing options or suggested entries to the user (such as drop-down menus). The user has the option to save the information input, or cancel. Similar screens may be shown for the change and remove ICS position options.

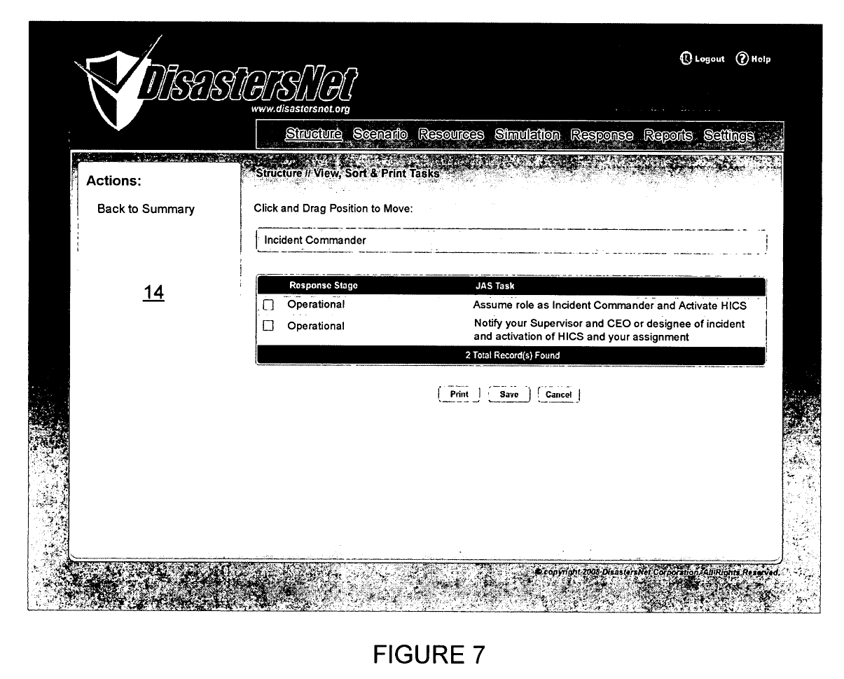

FIG. 7 shows the view, sort and print tasks screen under the structure option. FIG. 7 shows two JAS (Job Action Sheet) Tasks by response stage for the Incident Commander positions. These records can be selected, saved, sorted and printed by the user.

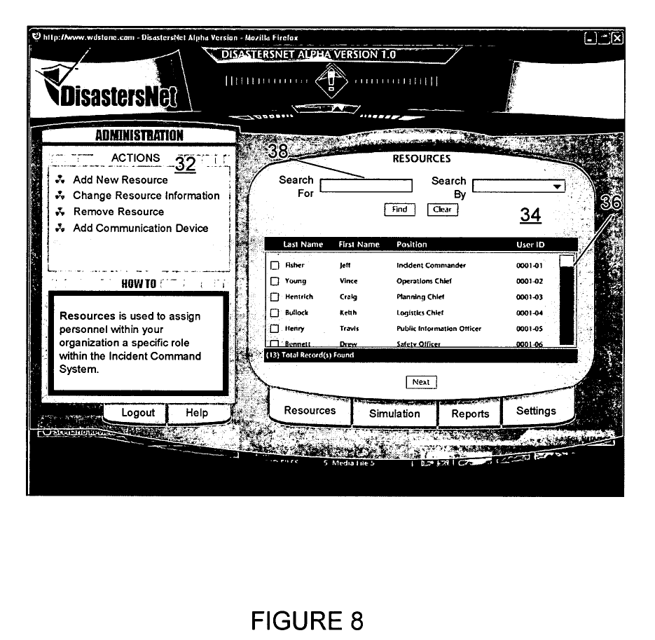

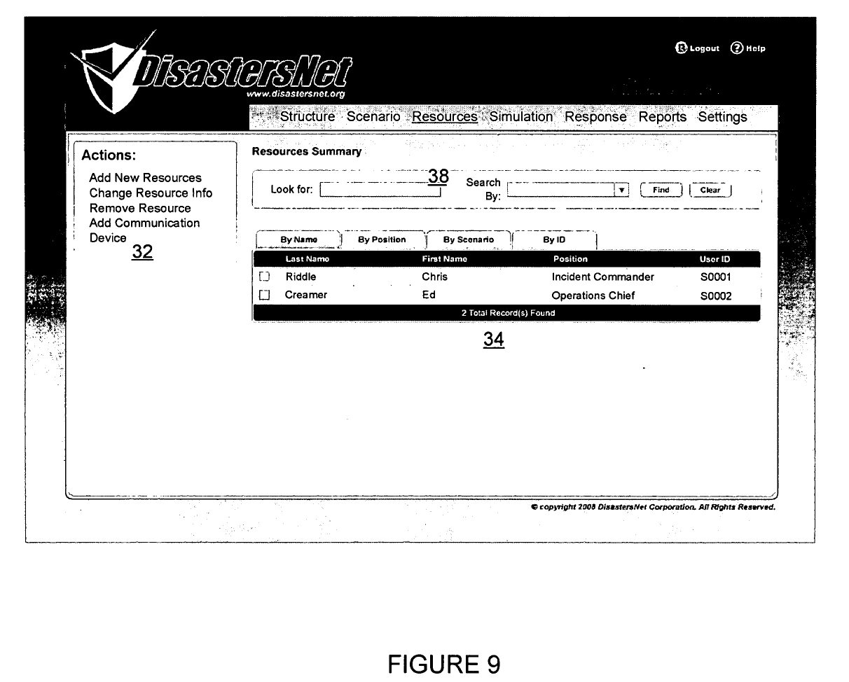

The Resources option 22 permits the user to add, modify, or remove specific individuals or personnel to a system database, and to assign a specific role or position to particular individuals. Resources also include the staff labor pool, volunteer labor pool, equipment and supplies, and beds (i.e., hospital beds). FIGS. 8 and 9 shows two exemplary embodiments of the base resources screen, which has action selections 32 on the left side of the screen and a resources list or table 34 on the right side of the screen. As seen in FIG. 9, the resources list or table may ordered by name, position, scenario, or user ID number. These components may be located elsewhere in other configurations.

The resources list 34 shows a listing of participants or individuals in the database, and provides means for the user to select desired individuals. Depending on the number of participants individuals to be shown, means for scrolling, such as a slider bar or button 36, may be provided. In one exemplary embodiment, the information for each participant may include the following: Name; Call Priority; ICS Position; ICS Position Direct Report; Email Address; Work Phone; Cell Phone; Pager; Home Phone; Fax Number; Hourly Rate; User ID; and Password. Means for the user to search 38 for a particular individual also may be provided.

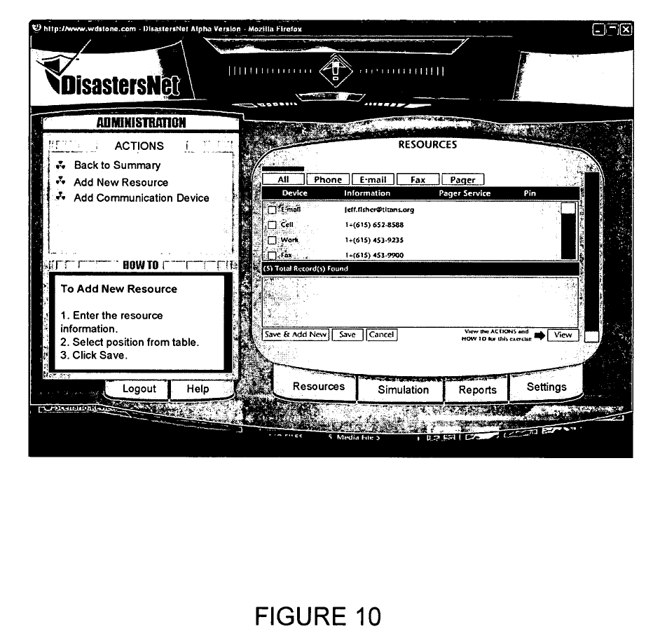

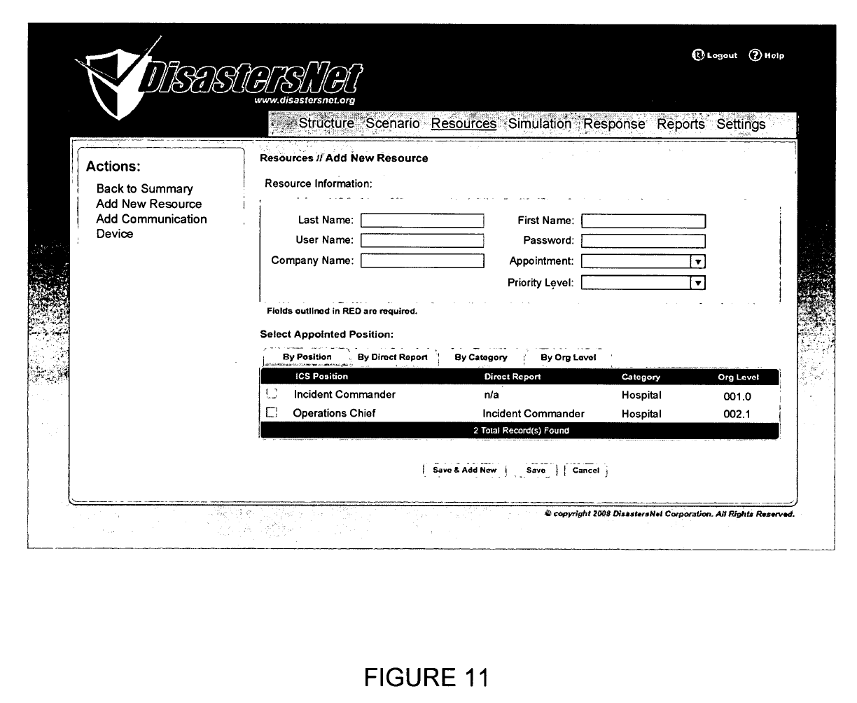

FIGS. 10 and 11 show exemplary embodiments of screens to add new resources under the resources option. Entry fields may include last name, first name, the name of the user inputting the entry, user password, company name, appointment position, and priority level. Pull-down menus, or similar means, may be used to provide the user optional choices for some or all of the fields. Some or all of the fields may be required. Similar screens may be used to change or remove resource information.

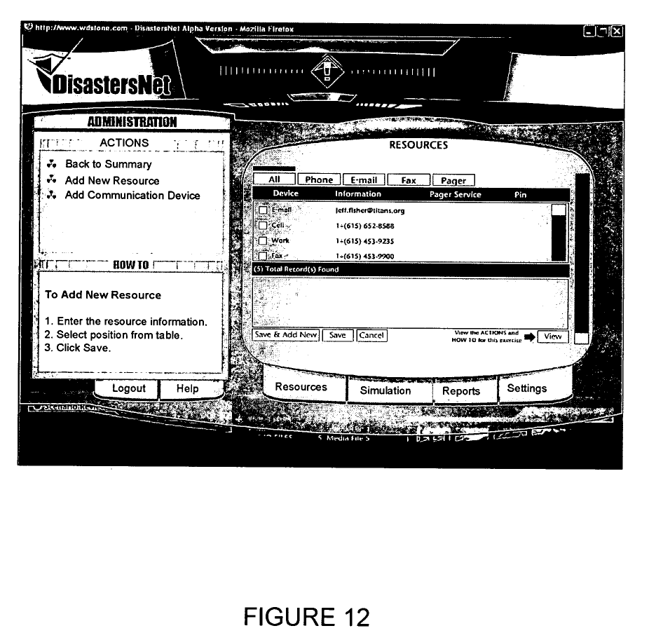

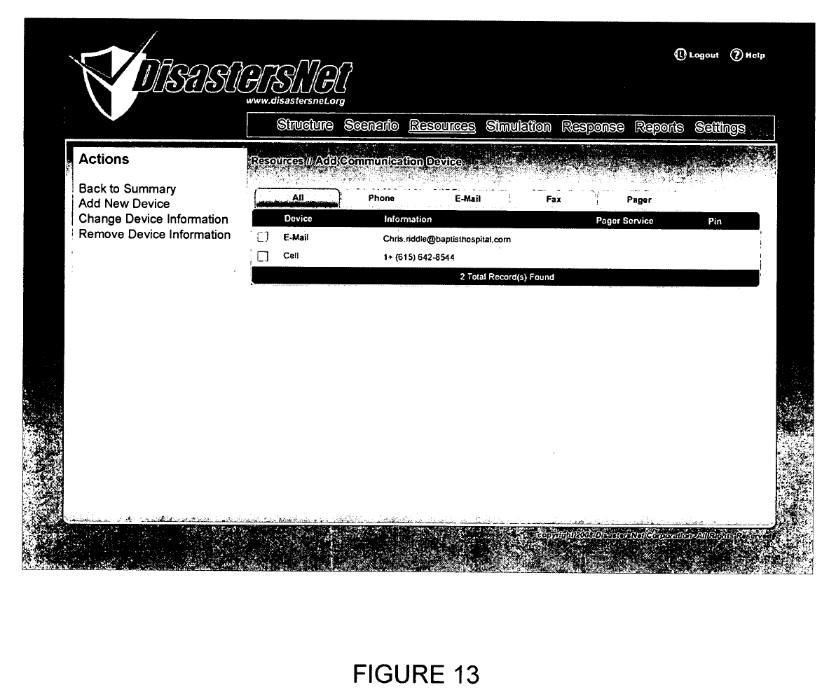

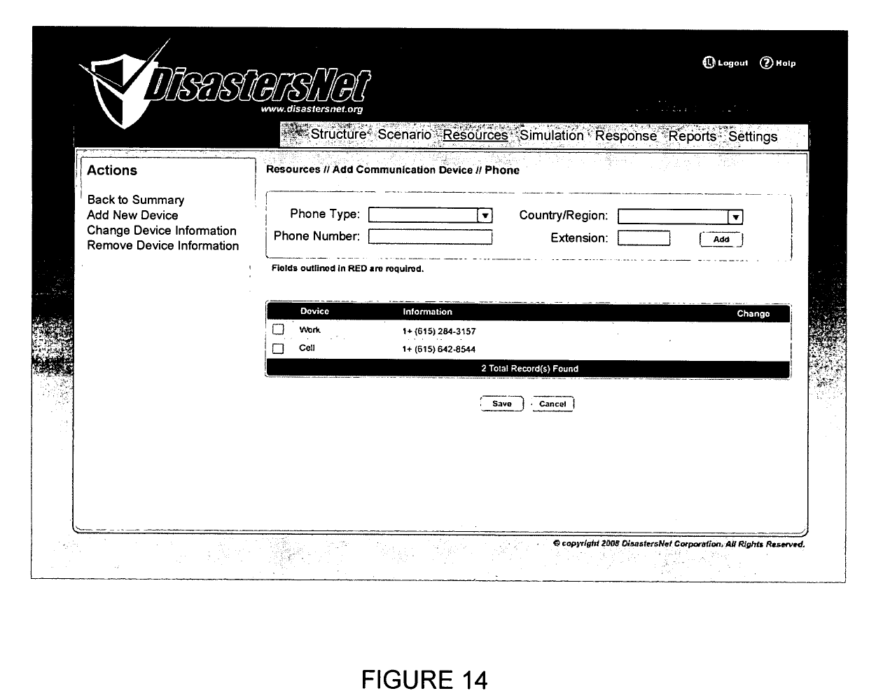

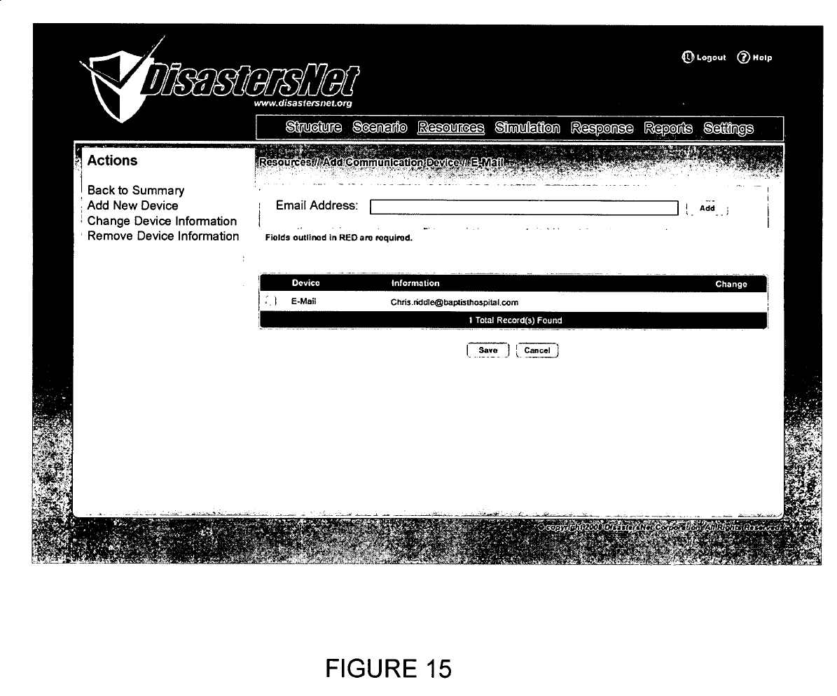

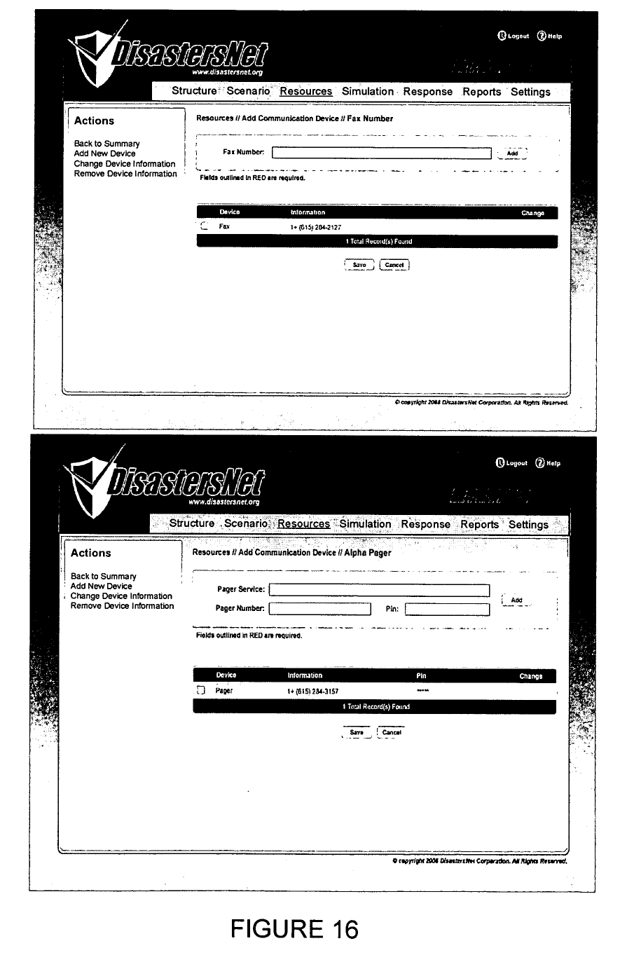

FIGS. 11 and 12 show exemplary embodiments of screens to add communication devices under the resources option. Communications devices include, but are not limited to, phones, cell phones, email, fax devices, and pagers. FIGS. 13-16 show exemplary embodiments of resource input screens for a phone, email, fax number, and alpha pager.

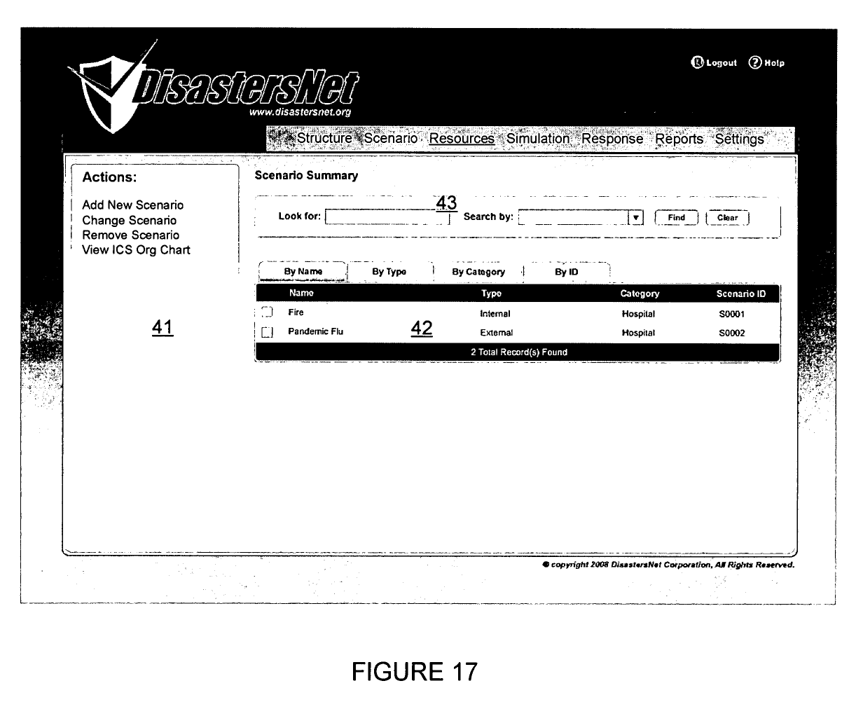

The Scenario option 23 permits the user to add, change and remove incident scenarios, and view the ICS organization chart. FIG. 17 shows an exemplary embodiment of a scenario options main or summary screen, which has action selections 41 on the left side of the screen and an exercise list or table 42 on the right side. The exercise table 42 can be ordered in a variety of ways: in the embodiment shown, these include by name, by type, by category, and by ID number. The ability to look or search for particular information or entries also may be provided 43. These components may be located elsewhere in other configurations.

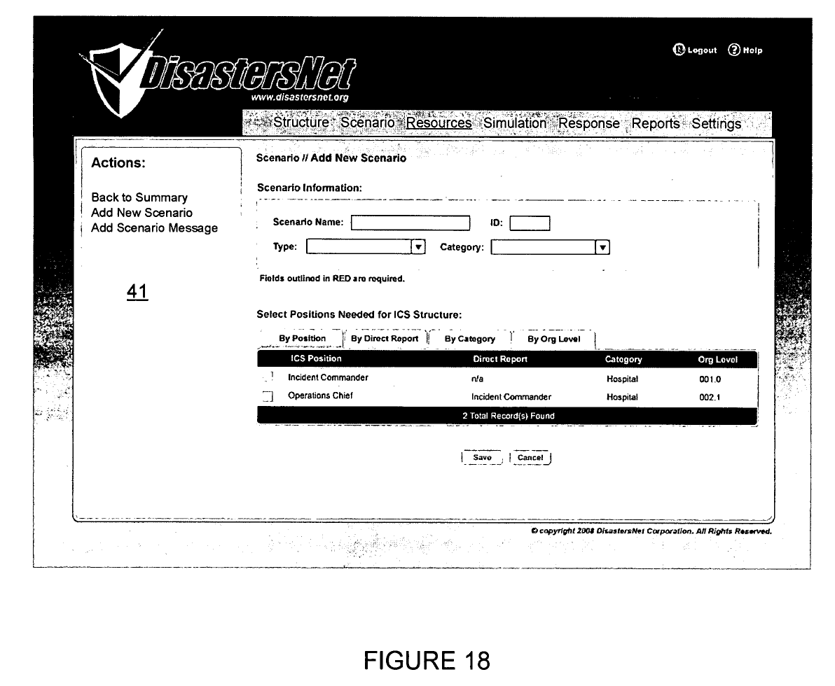

FIG. 18 shows an embodiment of a screen for adding a new scenario. In this embodiment, the information to be input includes scenario name, ID number, type, and category. Some or all of the entries may be required (in this embodiment, required fields are outlined in red), and some or all of the entry fields may be provided with means for providing options or suggested entries to the user (such as drop-down menus). The user also is prompted to select ICS positions that are needed for the scenario being added. The user has the option to save the information input, or cancel. Similar screens may be shown for the change and remove scenario options.

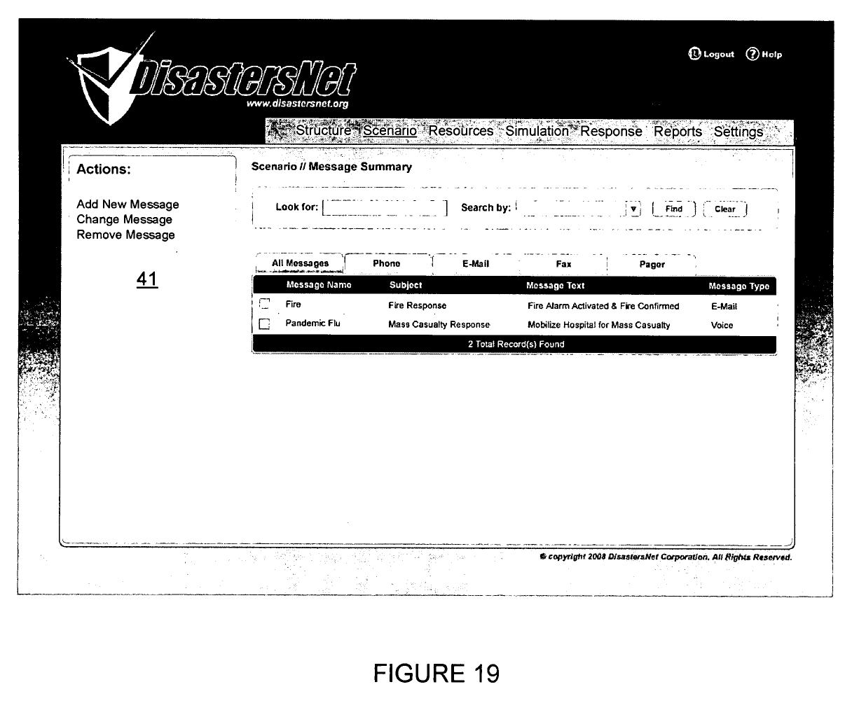

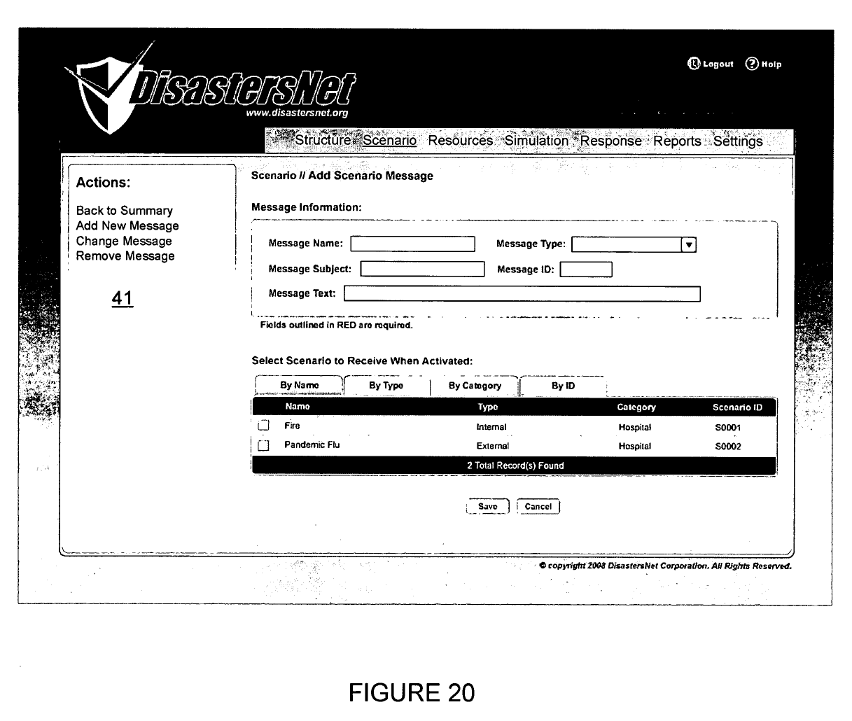

An option under adding a new scenario is managing scenario messages. FIG. 19 show an embodiment of a base screen for adding a message, including a list of possible messages in the system, and giving the options of adding, changing and removing messages. FIG. 20 shows an embodiment of a screen containing fields for adding a new scenario message, similar to the previous screens for adding scenarios or resources. Similar screens may be used to change or remove messages.

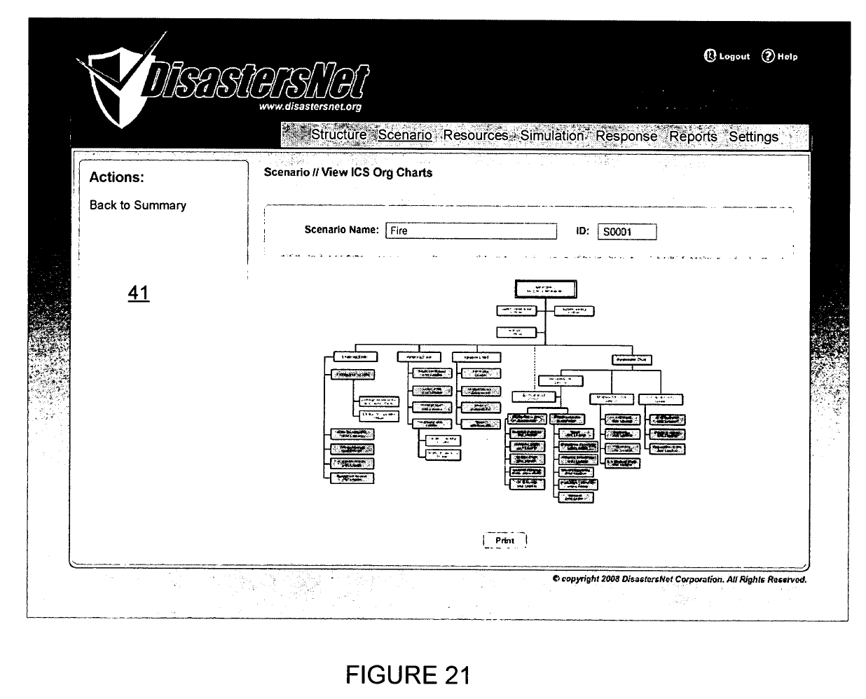

FIG. 21 shows an exemplary embodiment of a screen for viewing an ICS organization chart.

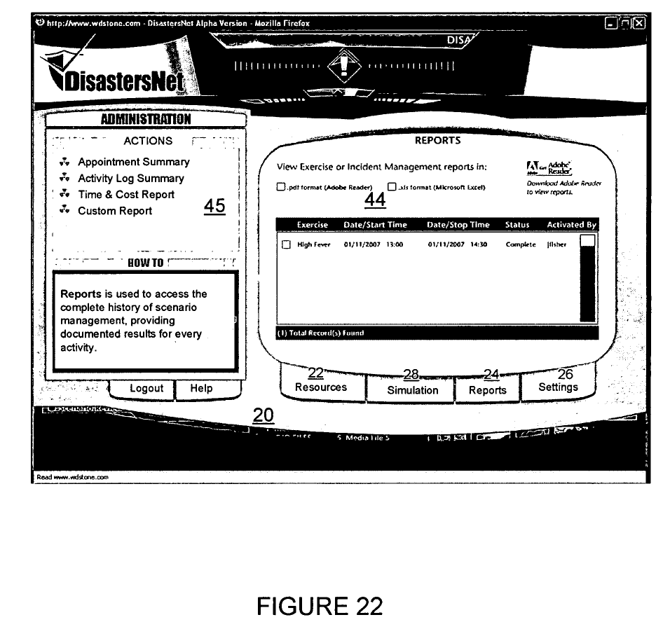

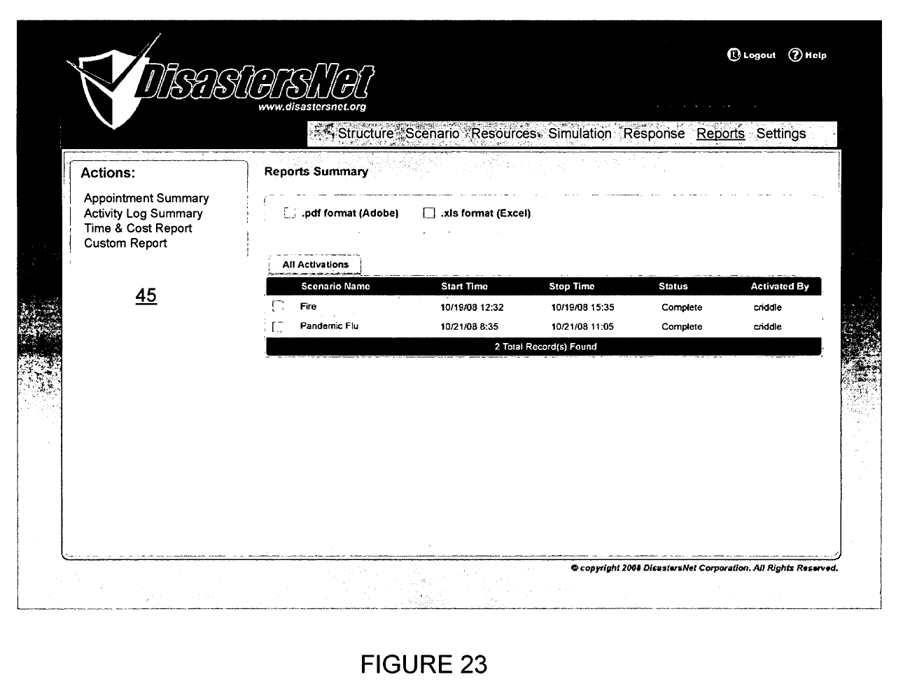

FIGS. 22 and 23 show two exemplary embodiments of the base Reports page, which is selected by the Reports option 24 as described above. A variety of pre-set or custom reports 45 regarding a simulation or event may be prepared and displayed, printed, saved, or sent electronically to a recipient. Various report formats can be selected, such as .doc, .txt, .pdf (Adobe), and .xls (Excel) 44. Examples of pre-set reports 45 include an appointment summary, activity log summary, and time & cost report. An option to prepare custom reports also may be provided.

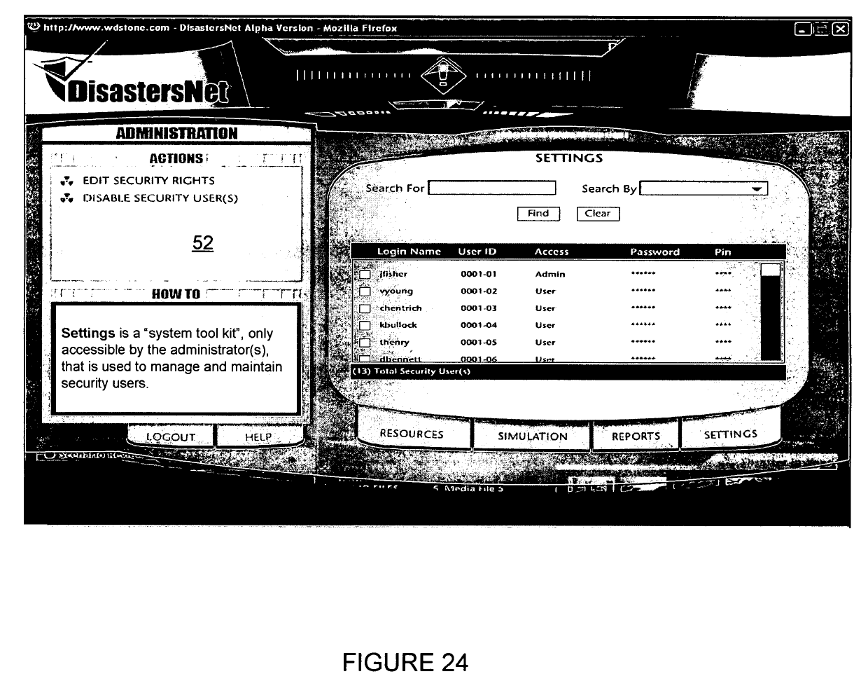

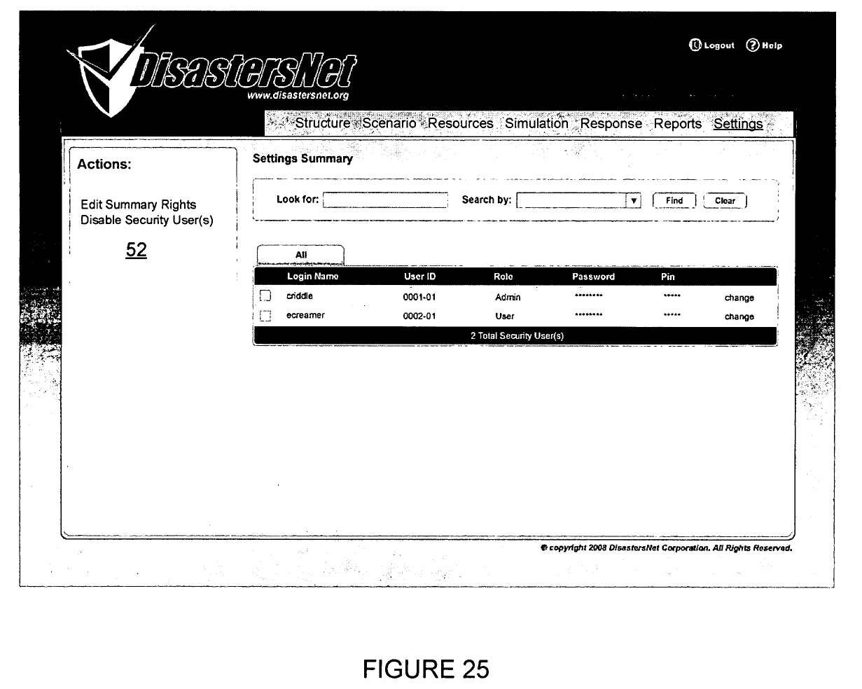

FIGS. 24 and 25 shows two samples of a Settings screen, which may be selected by means of the Setting option 26 as described above. From the Settings screen the user can provide, modify, edit, or disable 52 security rights for particular individuals or participants. The Settings screen may only be accessible to certain users, such as an administrator.

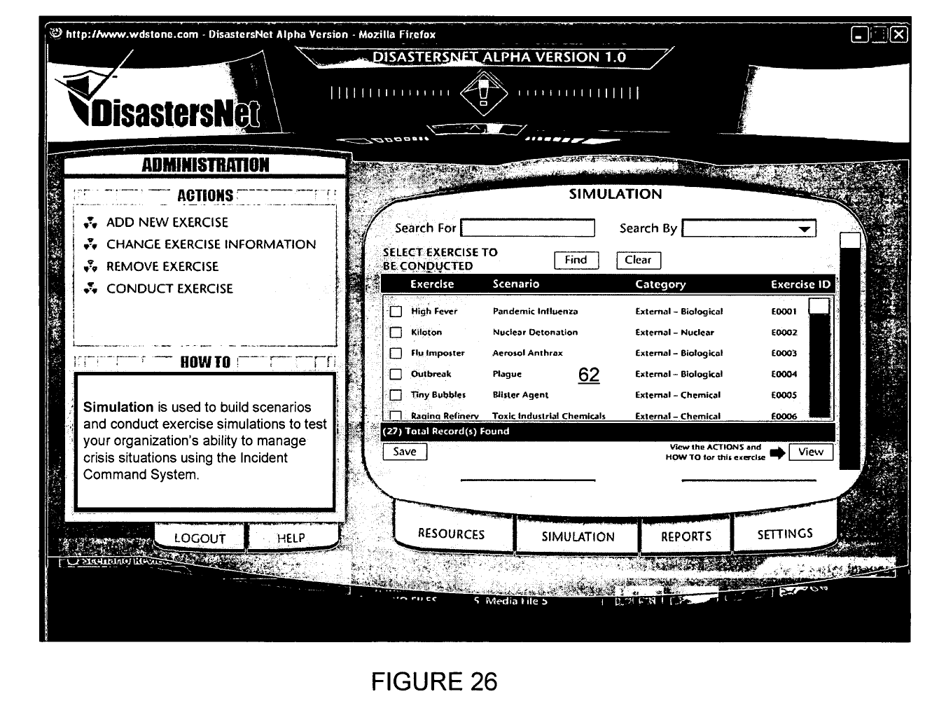

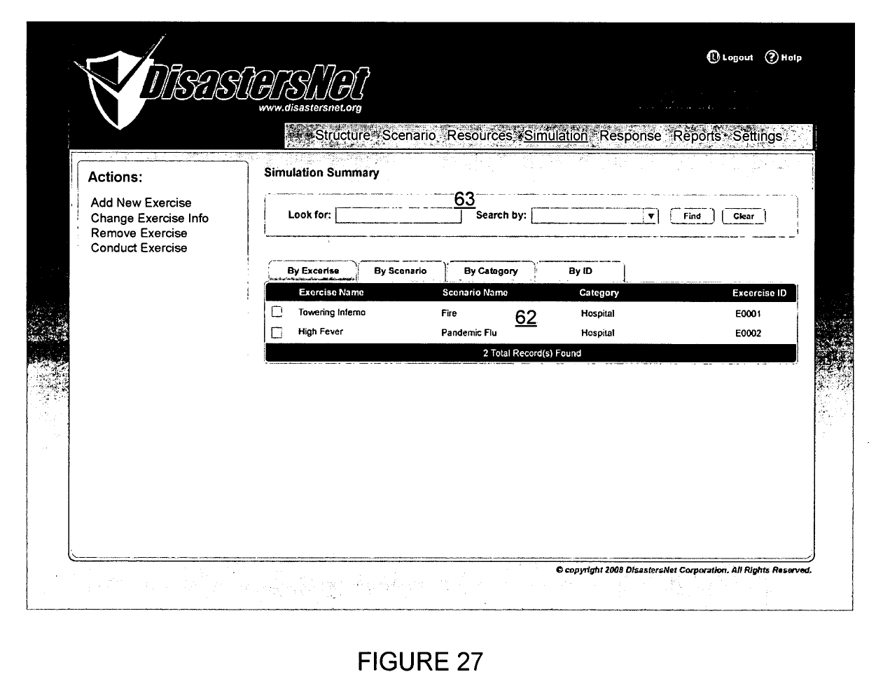

FIGS. 26 and 27 show two exemplary embodiments of the Simulation main or summary screen, which may be selected by means of the Simulation option 28 as described above. The simulation function allows the user to build and construct exercise simulations to test the user's organization's ability to manage crisis situations or events using the Incident Command System. Standard or custom ICS templates can be built. As seen, the user may select one of a variety of exercises 62. These exercises include versions of the standard HICS (Hospital ICS) exercises, with moving and static images, sounds, and voiceovers added, as well as custom exercises. The exercise list can be sorted by exercise, scenario, category, or ID number, or by some other parameter. A search function 63 also may be provided.

In one exemplary embodiment, possible exercises include, but are not limited to, the following:

| Exercise Name | Scenario | Category | Exercise ID |
|---|---|---|---|
| High Fever | Pandemic Influenza | External - Biological | E0001 |
| Kiloton | Nuclear Detonation | External - Nuclear | E0002 |
| Flu Imposter | Aerosol Anthrax | External - Biological | E0003 |
| Outbreak | Plague | External - Biological | E0004 |
| Tiny Bubbles | Blister Agent | External - Chemical | E0005 |
| Raging Refinery | Toxic Industrial Chemicals | External - Chemical | E0006 |
| The Twitch | Nerve Agent | External - Chemical | E0007 |
| Green Cloud | Chlorine Tank Explosion | External -Chemical | E0008 |
| Shake Up | Major Earthquake | External - Natural Disaster | E0009 |
| Category Five | Major Hurricane | External - Natural Disaster | E0010 |
| Dirty Bomb | Radiological Dispersal Devices | External - Radiological | E0011 |
| The Detonator | Improvised Explosive Device | External - Explosives | E0012 |
| Paralysis | Food Contamination | External - Biological | E0013 |
| Shut-Down | Cyber Attack | External - Cyber | E0014 |
| Countdown | Bomb Threat | Internal - Bomb | E0015 |
| Clear Out | Evacuation | Internal - Evacuation | E0016 |
| Towering Inferno | Fire | Internal - Fire | E0017 |
| Flammable Fumes | Hazardous Material Spill | Internal - Chemical | E0018 |
| No Vacancy | Hospital Overload | Internal - Surge | E0019 |
| Gone Mad | Hostage/Barricade | Internal - Hostage | E0020 |
| Code Pink | Infant/Child Abduction | Internal - Infant Abduction | E0021 |
| Dam Break | Internal Flooding | Internal - Flood | E0022 |
| Sweat Shop | Loss of HVAC | Internal - Utilities Loss | E0023 |
| Black Out | Loss of Power | Internal - Utilities Loss | E0024 |
| Disanni | Loss of Water | Internal - Utilities Loss | E0025 |
| Twister | Severe Weather | Internal - Severe Weather | E0026 |
| Deserted | Work Stoppage | Internal - Staffing | E0027 |

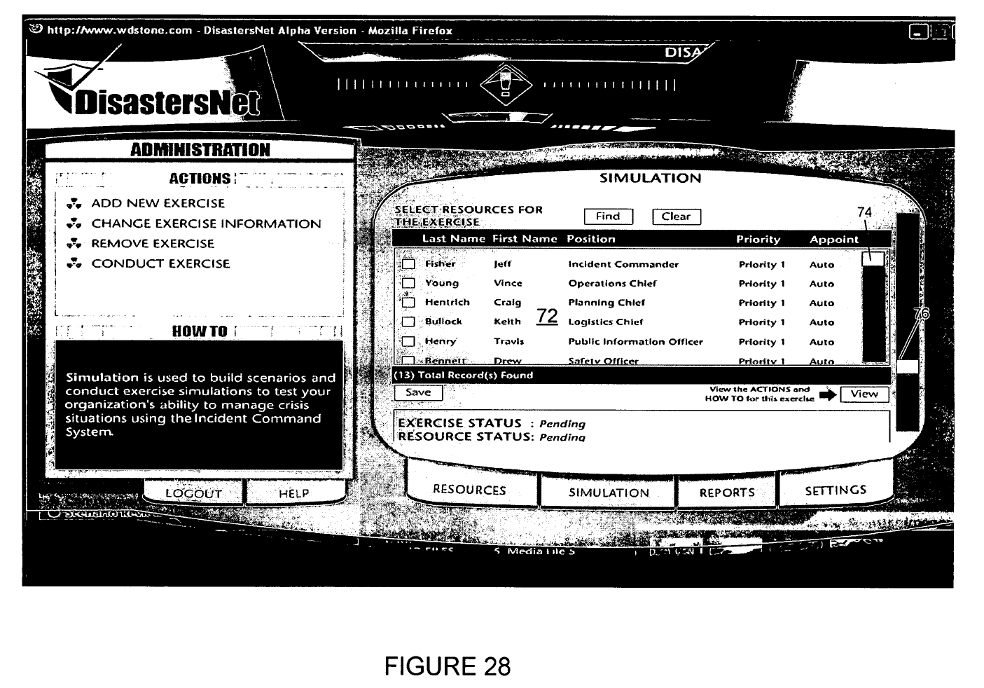

After selecting the exercise, the user may be directed to select resources (i.e., participants) 72 for the exercise, as seen in FIG. 28. In one exemplary embodiment, as seen in FIG. 28, dual sliders may be used in the resource selection window, one (inside) slider 74 is used to scroll the list of individuals, while the second (outside) slider 76 is used to scroll the resource window. These dual sliders may also be used for other screens and windows in the system.

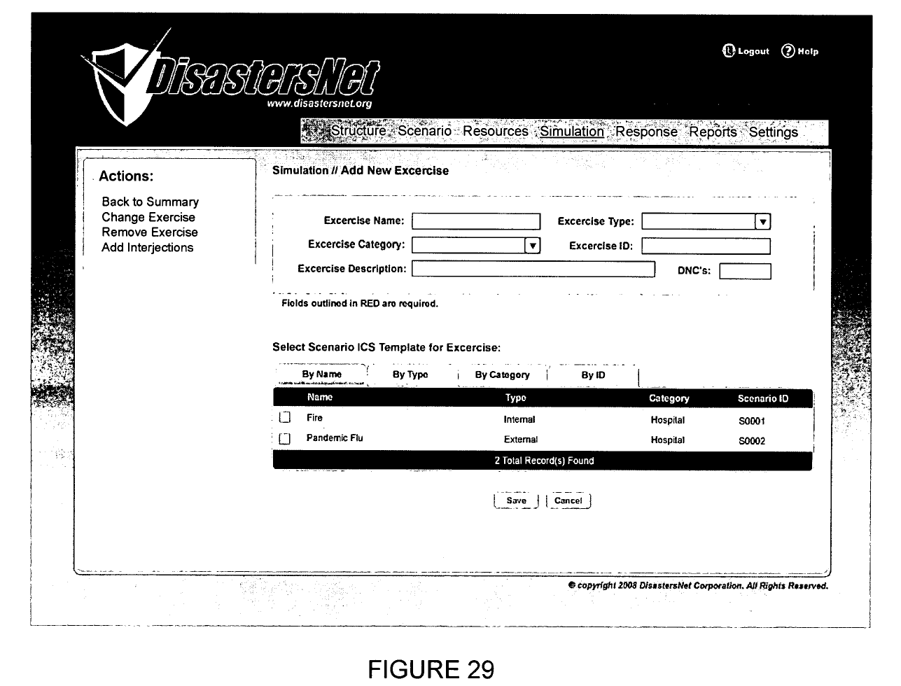

FIG. 29 shows an embodiment of a screen for adding a new exercise for use with simulations. Similar screens may be used to change or remove exercises.

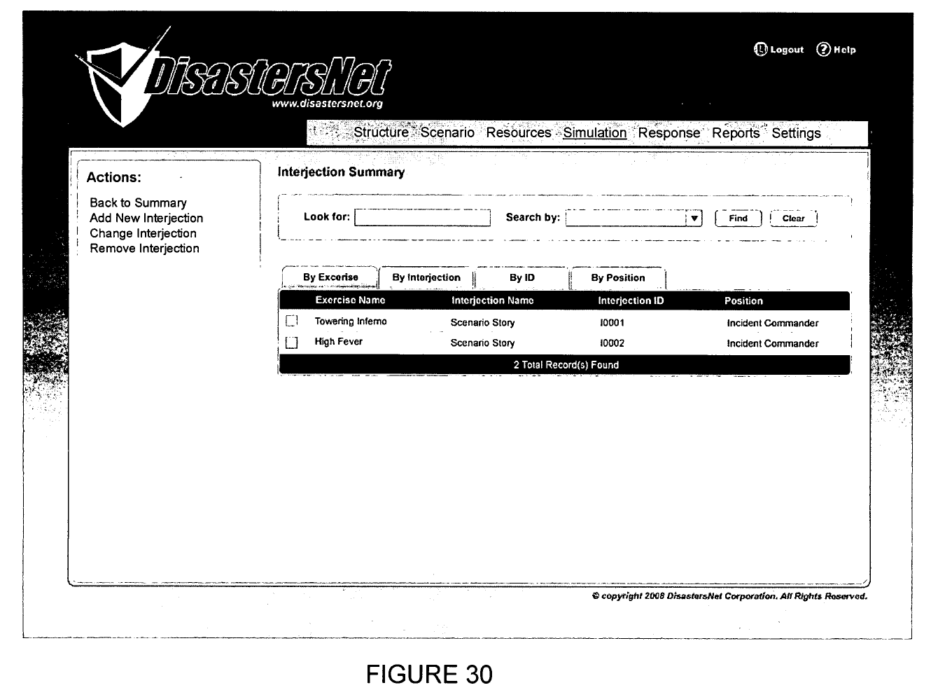

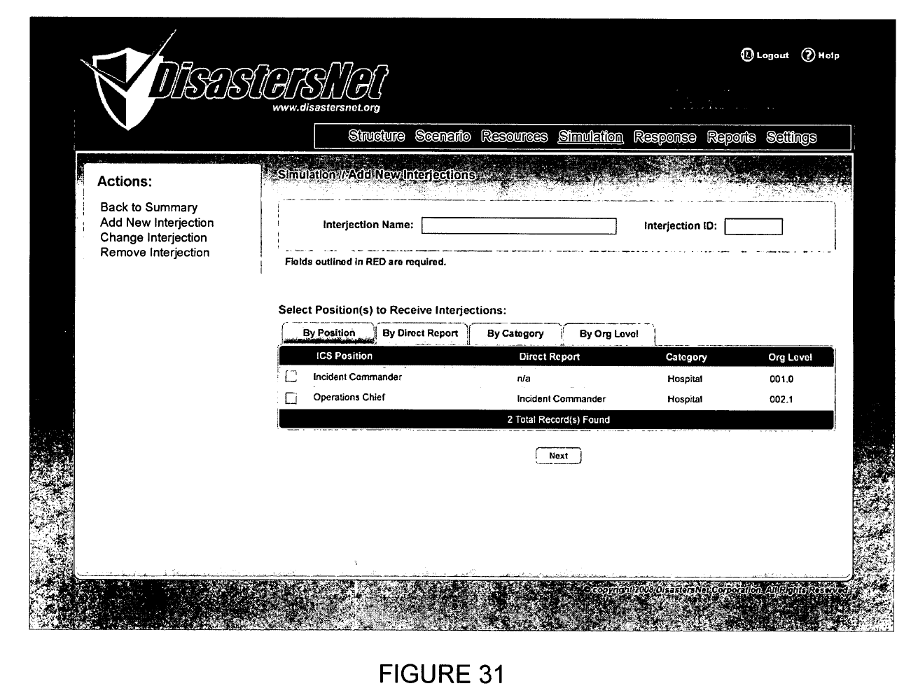

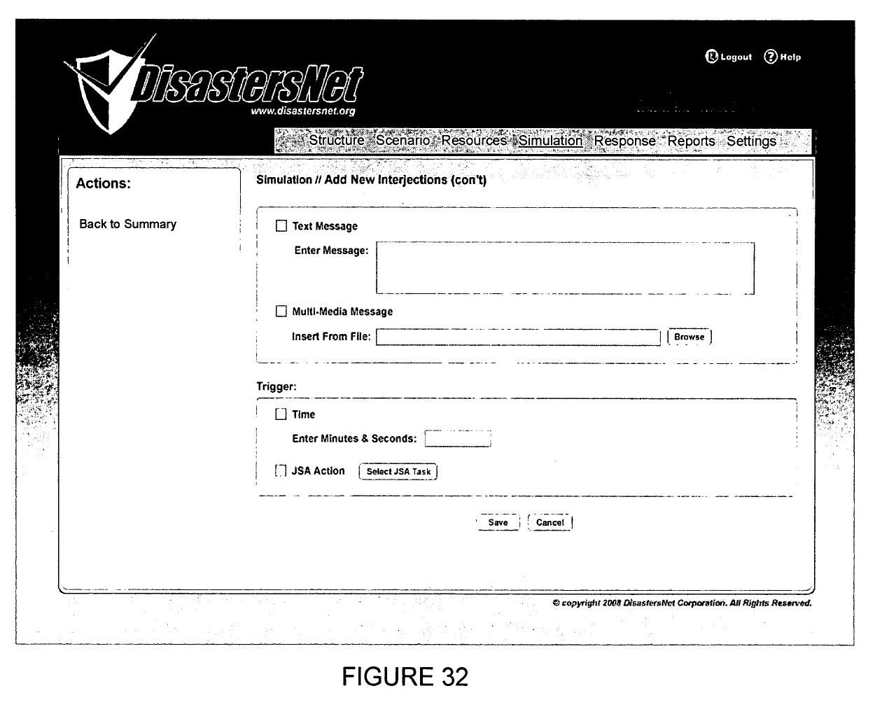

Users have an option under the exercise screen of adding, changing or modifying interjections. FIG. 30 shows an embodiment of an interjection summary screen, while FIGS. 31 and 32 shows screens for adding new interjections. Similar screens may be used to change or remove interjections.

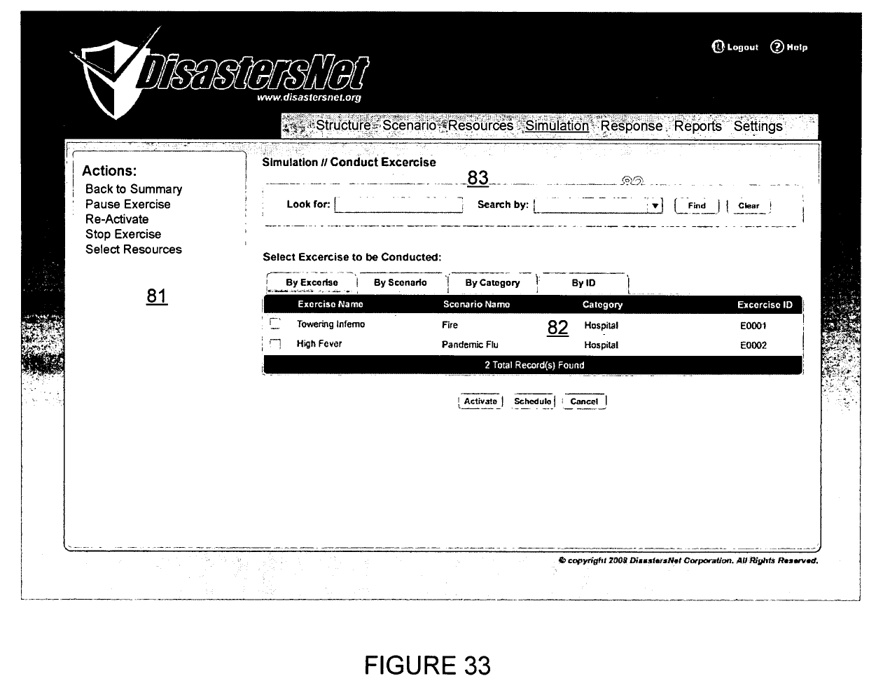

Under the Simulation option, the user and selected participants can elect to conduct an exercise. FIG. 33 shows a “conduct exercise” main or summary page, which has action selections 81 on the left side of the screen and a exercise list or table 82 on the right side. The exercise table 82 can be ordered in a variety of ways: in the embodiment shown, these include by exercise name, by scenario, by category, and by ID number. The ability to look or search for particular information or entries also may be provided 83. These components may be located elsewhere in other configurations.

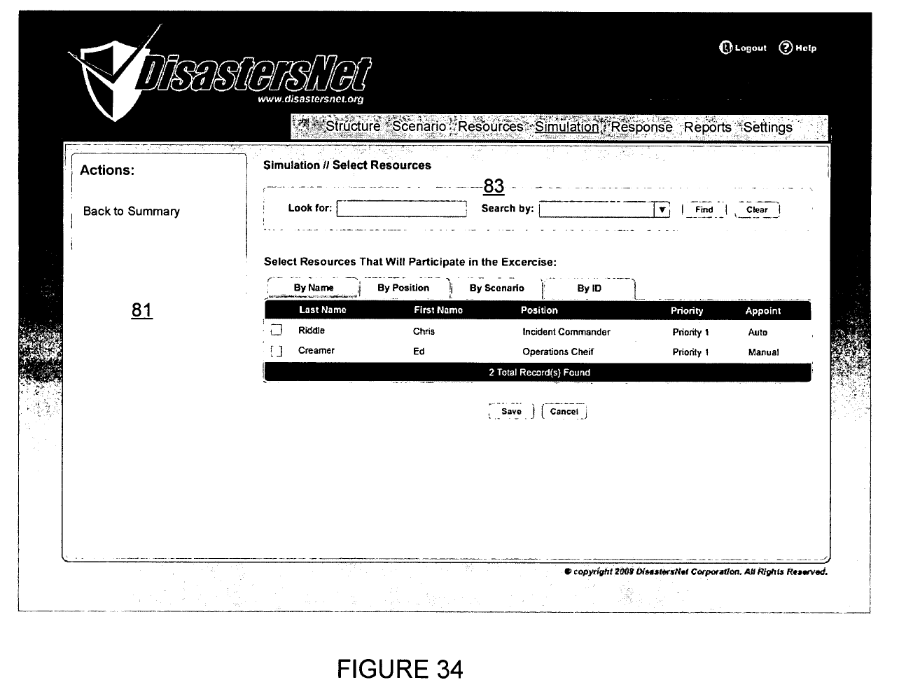

FIG. 34 shows a screen for selecting resources (including participants) for the exercise. This screen contains similar components to other screens discussed herein.

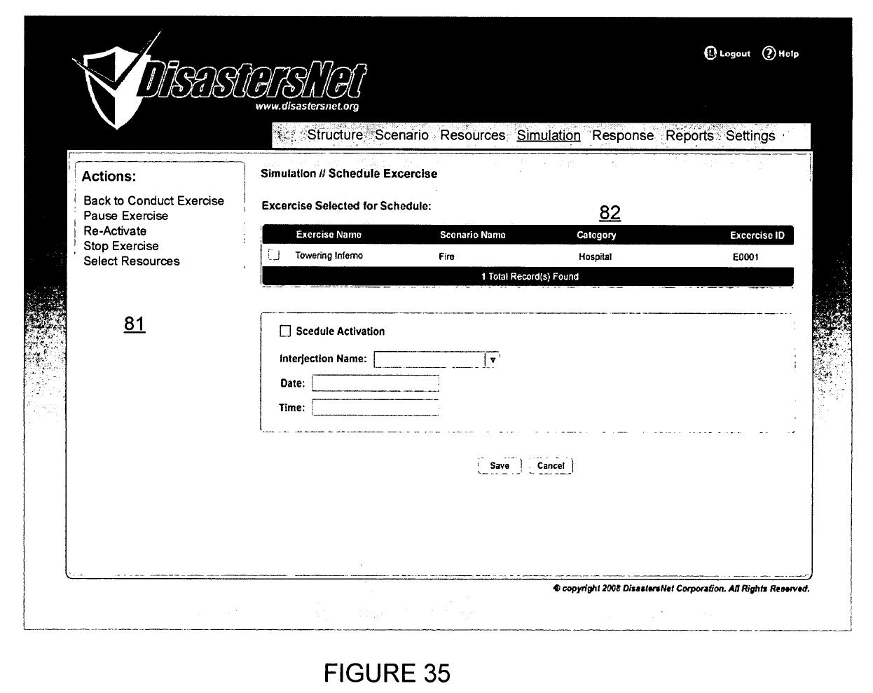

As shown, an exercise can be activated immediately, or scheduled to occur at a particular date and time. Options are provided to pause the exercise, re-activate a paused exercise, and stop the exercise 81. FIG. 35 shows a sample of an exercise scheduling screen.

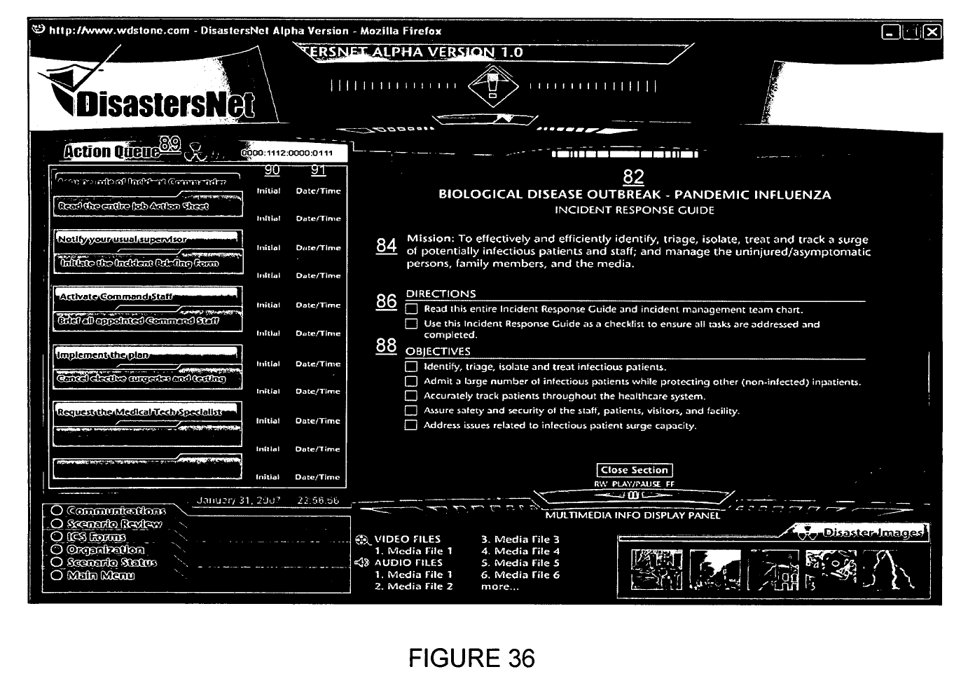

FIG. 36 shows an alternative exemplary embodiment of an Incident Response Guide describing the mission for a pandemic influenza outbreak. The guide contains a description of the mission 84, a list of directions 86, and a list of objectives 88. Also shown is an Action Queue 89, which lists a series of actions to be taken by the user and other participants. The user can activate particular action steps by highlighting and/or clicking on the tabs in the Action Queue 89. The Action Queue 89 also may contain entries for initials 90 and date/time 91 to indicate when a particular action item has been completed.

Information about the scenario, ICS forms, and other items may be accessed through other tabs or buttons on the page. Communications between participants, and simulated meetings, may also be initiated by this means. As shown in FIG. 36, these tabs or buttons are located at the bottom of the page.

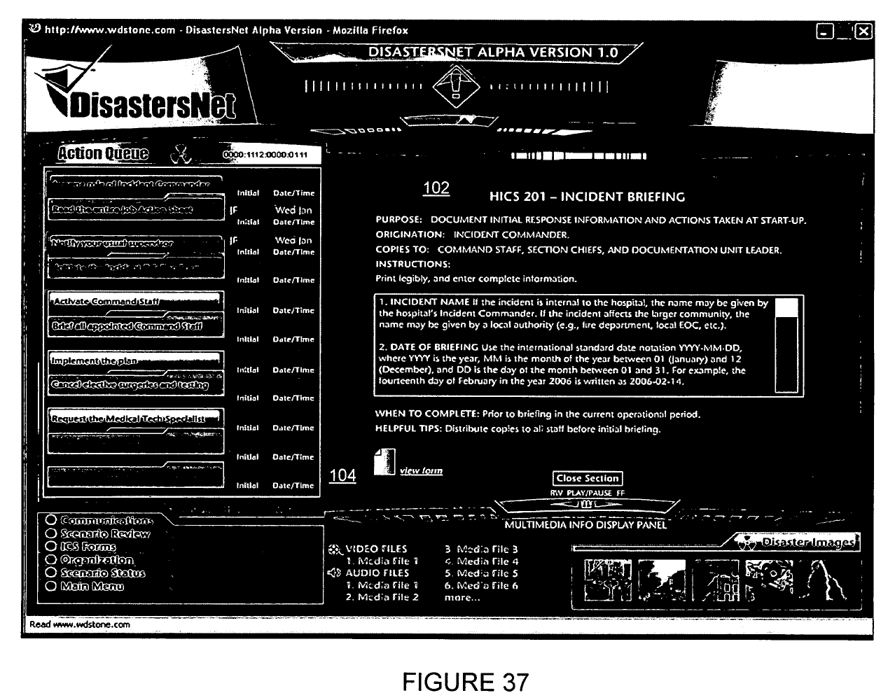

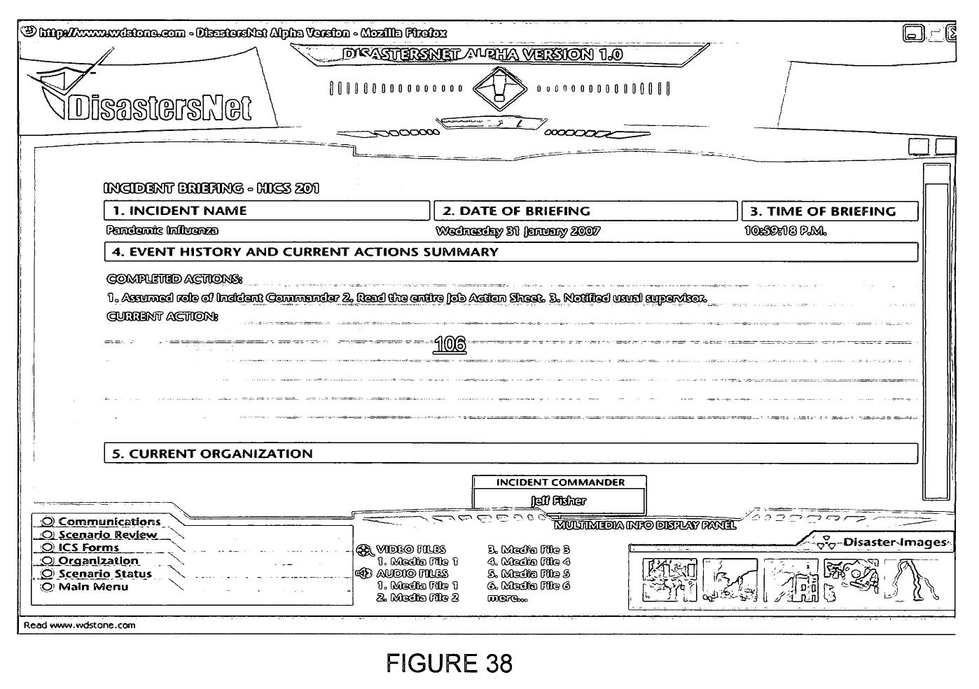

FIG. 37 shows an example of a scenario with several Action Queue steps taken. The viewing window on the right shows information about HICS 201-Incident Briefing 102, and the user also is provided the option 104 of seeing the related Incident Briefing Form 106, as shown in FIG. 38.

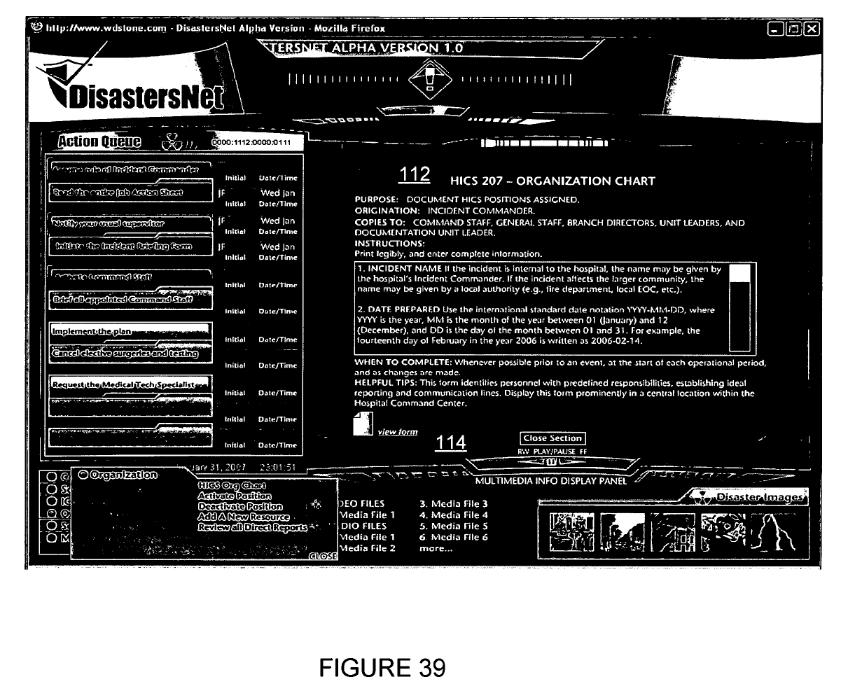

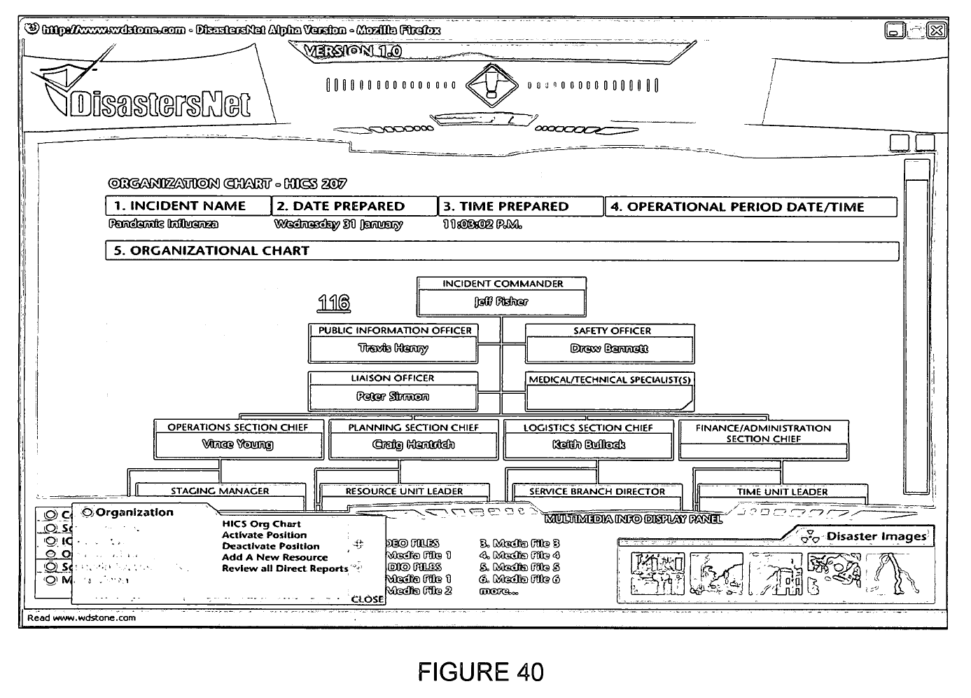

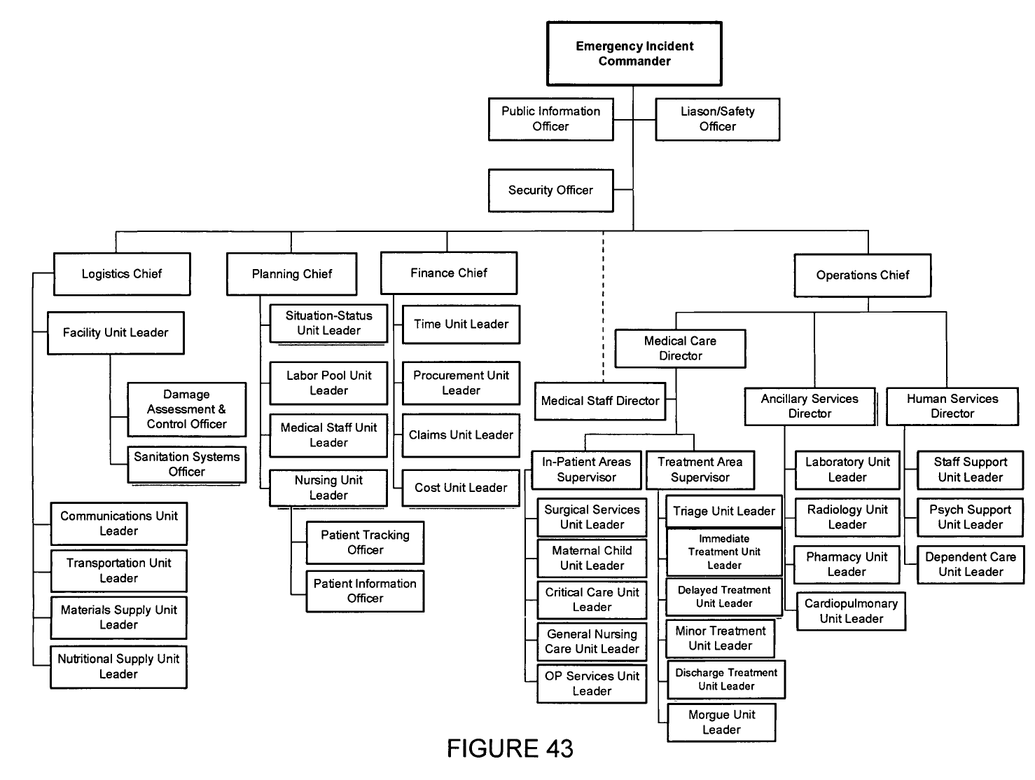

FIG. 39 shows an example of a scenario that has proceeded to the Activate Command Staff stage. The viewing window on the right displays information about HICS 207-Organization Chart 112, and also provides the option 114 of viewing the related organizational chart screen 116, as shown in FIG. 40. Participants may be assigned to particular roles from the organizational chart. In one embodiment, the user may click on a box in the organizational chart, and be provided with a list of participants. A full view of an organizational chart listing roles or positions in accordance with one exemplary embodiment is shown in FIG. 43.

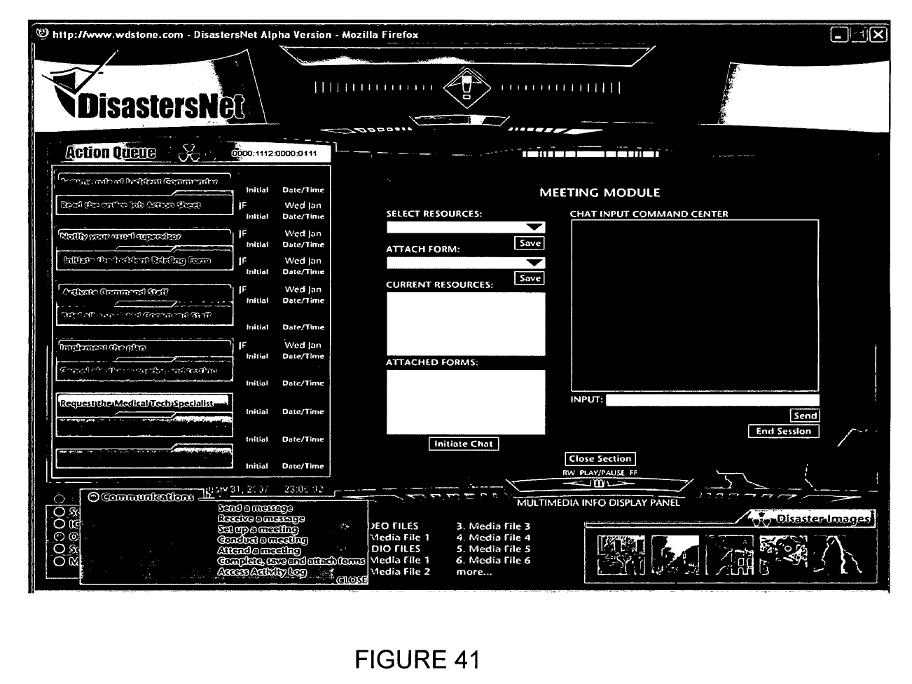

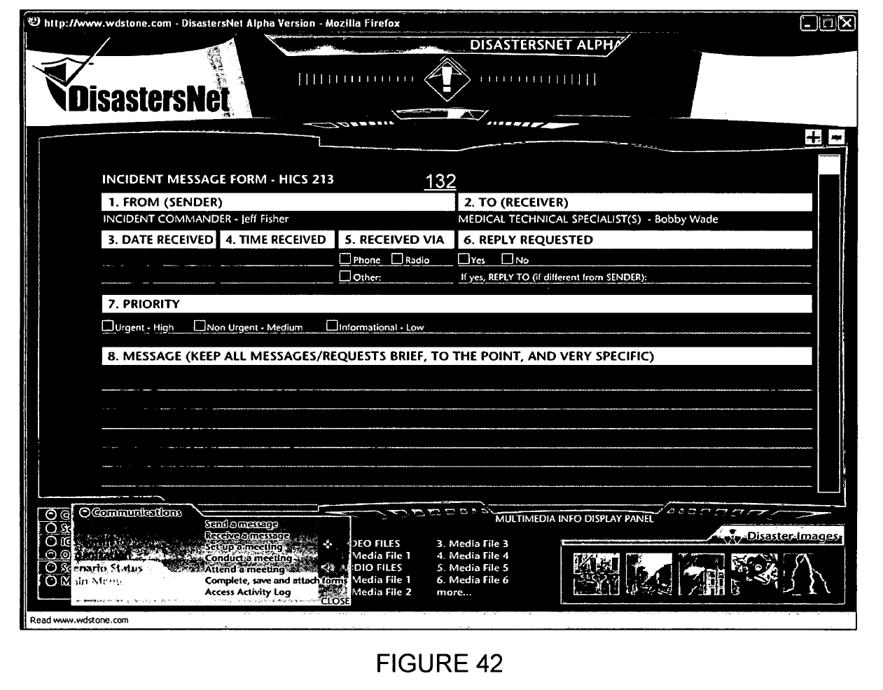

FIGS. 41 and 42 show an example of how the Meeting Module is initiated, and how messages may be sent. The communications tab 122 shown on FIG. 41 provides a number of communications options, as shown. The incident message form 132 shown on FIG. 42 provides the user a variety of options to communicate to a participant or multiple participants. As noted above, a variety of simulations can be run for training personnel at an organization. The same scenarios, or variants thereof, can be used for testing and evaluation of the personnel and organization. Not only is the invention a more efficient and effective way of providing this training and testing than the present “table top” techniques, and allows the participation of individuals at different locations, the cost of this training and testing is substantially less.

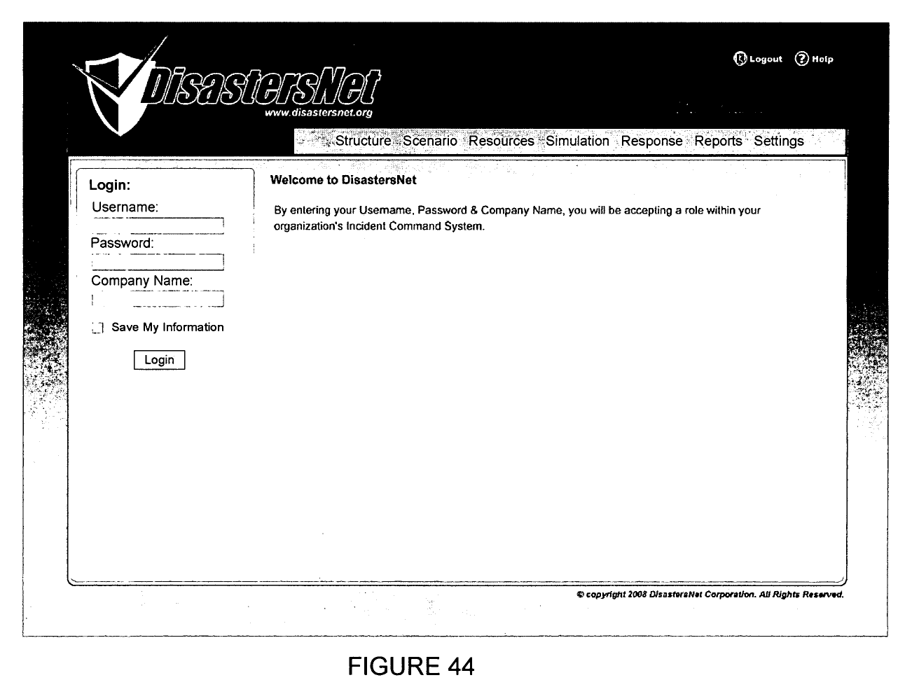

FIG. 44 shows a log-in screen for a participant in an exercise or an event, where the participant does not have access to administrative functions (such as those described above). Participants log in to be able to participate in training, running an exercise, or responding to an incident.

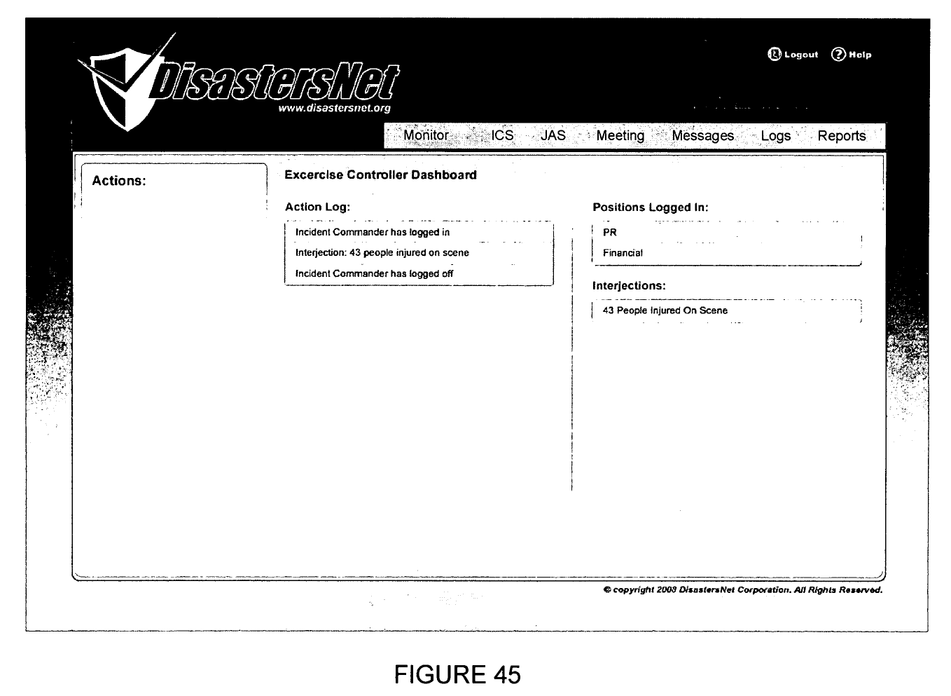

FIG. 45 shows an embodiment of the exercise controller dashboard for use by the individual running the exercise. From the dashboard, the controller can monitor actions taken, communications, the status of participants, and other information about the exercise.

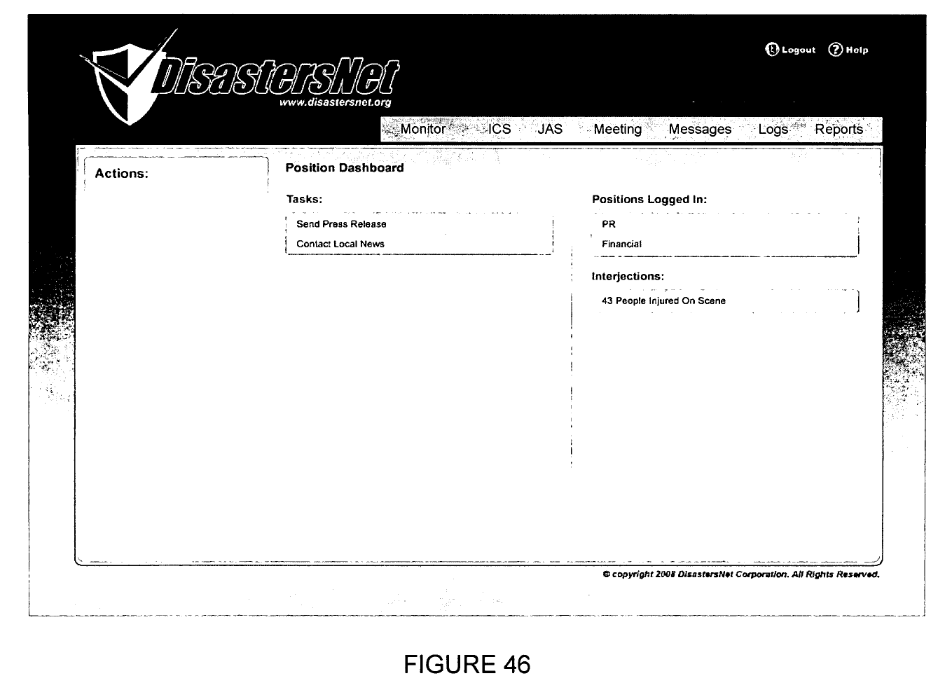

FIG. 46 shows an embodiment of the dashboard viewed by a participant in the exercise. The dashboard options depend upon the position in the ICS occupied by that participant. From the dashboard, the controller can take actions, accomplish tasks, engage in communications, view the status of participants, and view other information about the exercise.

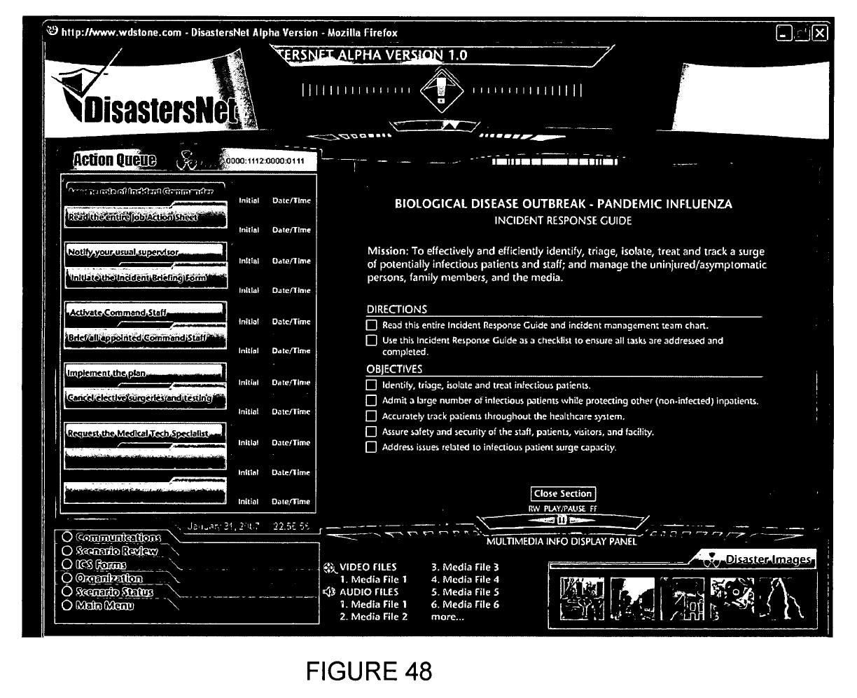

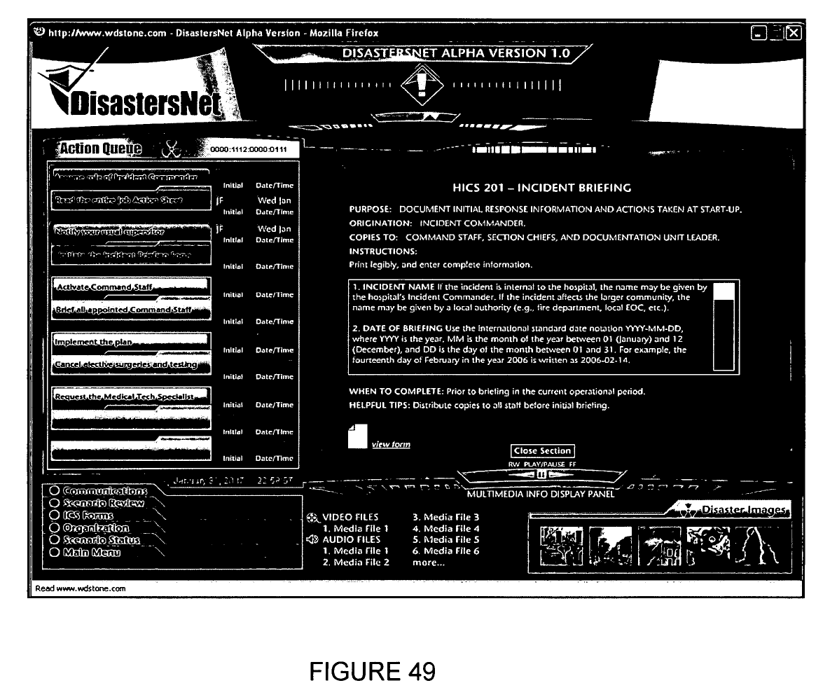

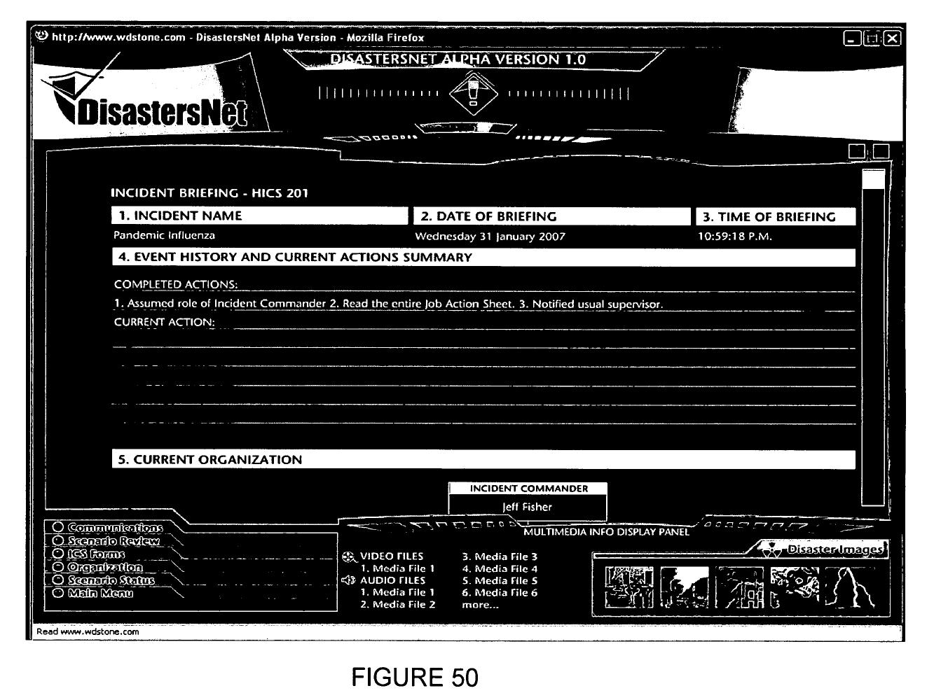

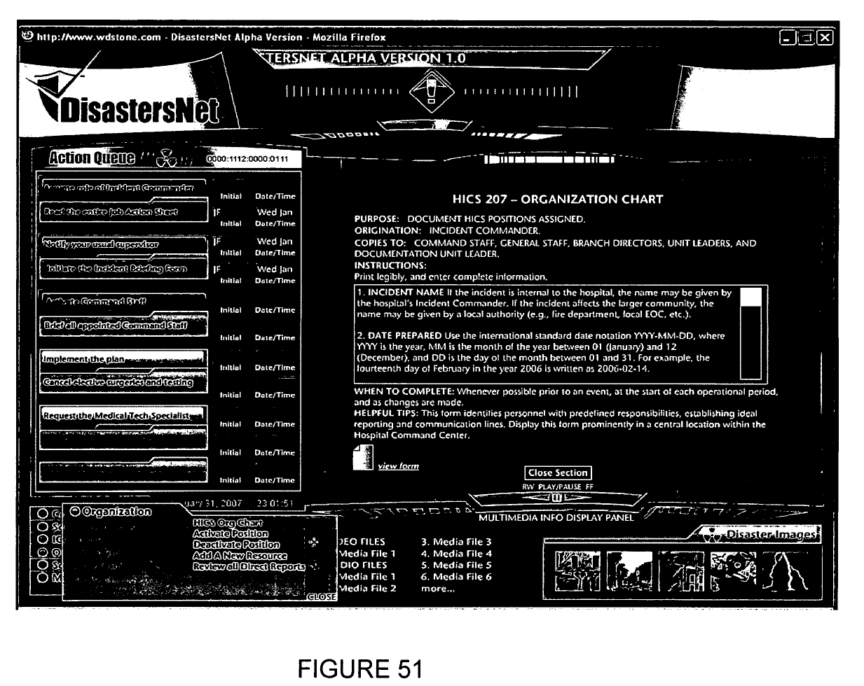

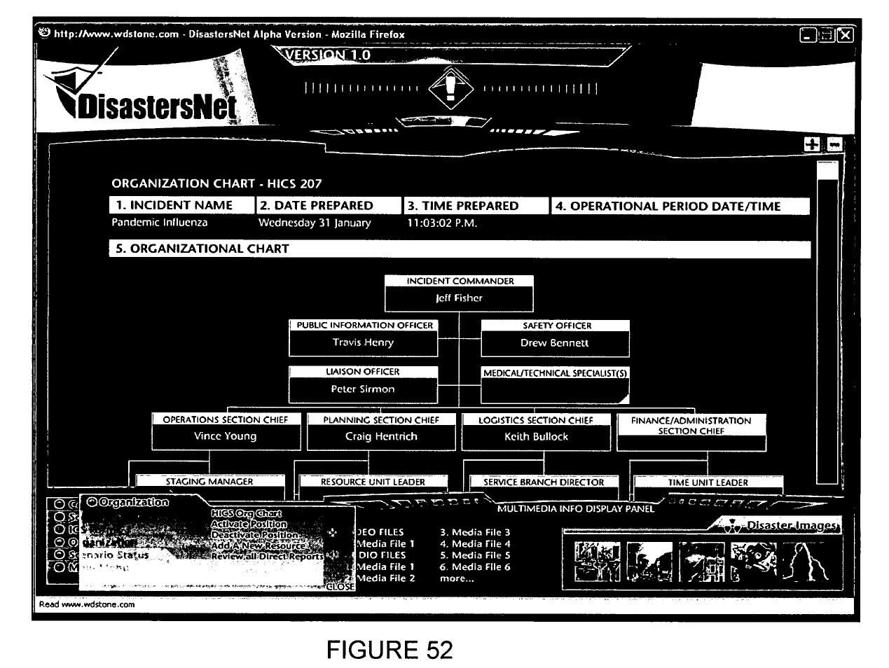

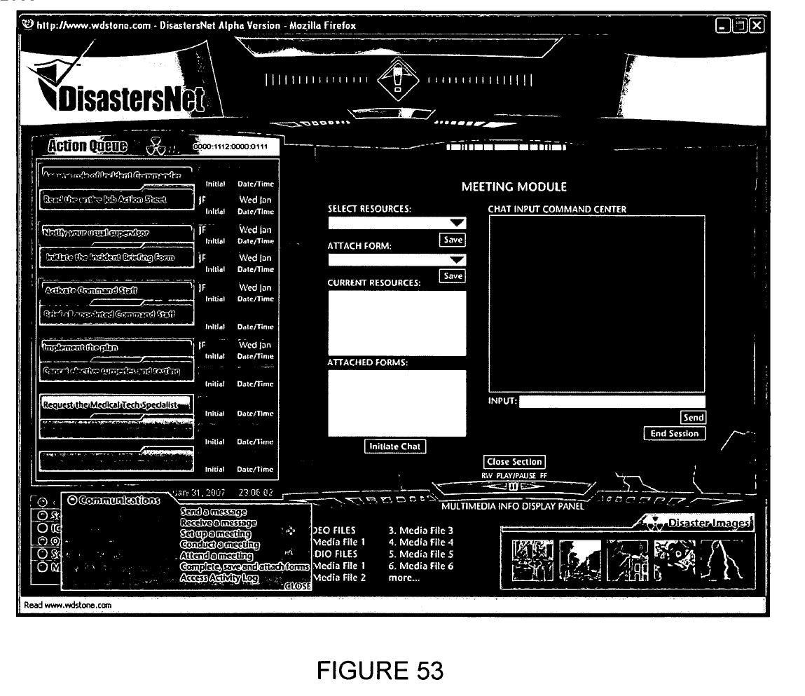

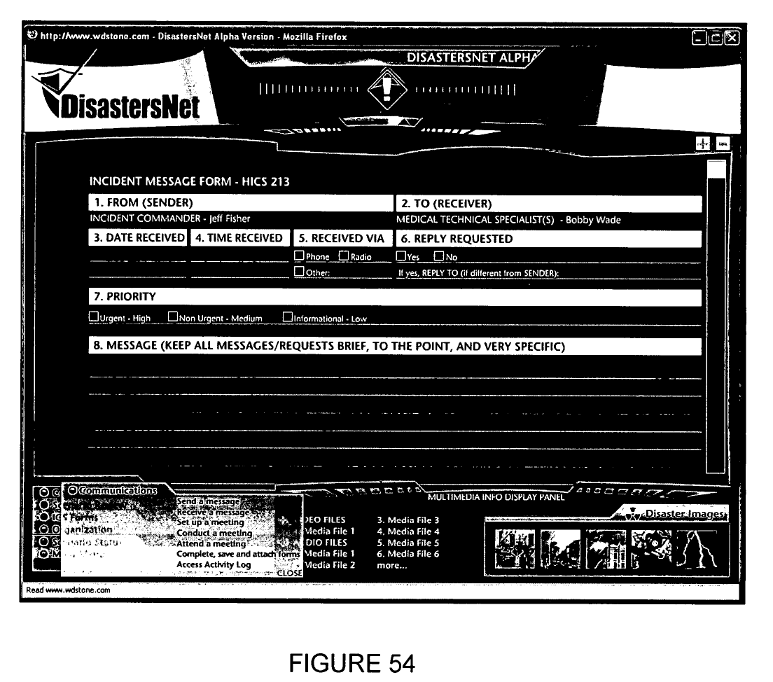

An example of the conduct of an exercise follows (as shown in FIGS. 48 through 54). Potential participants receive a communication, such as an email, informing them that their participation in a web-based disaster exercise is requested, and informing them of their assigned/appointed position. The communication may include a unique user ID and password that allows them to log into the exercise interface for this appointed position at the appropriate time. The participants log into the website and enter their unique user ID and password, and are taken to an greeting page or screen that acknowledges the user's position appointment. The participants are then taken to a scenario review page, which may have audio and streaming video displayed to describe the exercise and engage the participants. Each participant is then taken to a position-specific page, where scenario information specific to the appointed position is provided to established the mindset for the position. Each participant then is taken to a position control panel, which gives the participants the ability to perform the role of their assigned position in the Incident Command System. An Exercise Monitor provides participants with instructions, interjections, images and streaming video related to their appointed position. A Job Action Sheet provides a scrollable list of responsibilities that must be completed for the assigned position; the action must be taken before the system will allow participants to check the Job Action Sheet task as complete.

The Position Control Panel allows the participant to accomplish a number of functions. One function is to view the ICS (or HICS) organization chart, which can be used to view appointed positions and obtain information each position role and their direct reporting responsibilities. For example, the liaison/safety officer may function as the incident contact person for representatives from other outside agencies, with direct reporting responsibility to the incident commander. The ICS organizational chart updates as personnel log on to the system.

Some positions may themselves have appointment power for subordinate positions. For example, the incident commander may have the power to appoint all appropriate section chiefs and medical staff director positions. The person doing the appointing can do so by clicking on the title or person to appoint a position. Doing so opens up a position appointment screen, where the participant enters the name, physical location or post, and email address for the person appointed.

Another function is to send and received messages as needed to anyone in the organizational chart within the chain of command. The participant can initiate the message to any position that has been appointed by clicking on the position in the organizational chart. This opens a message form, with space to input a message, and the ability to indicate the type of message (e.g., request action; request information; provide information update; report action taken; report response to request; etc.). The message may be dated and time stamped. After typing in the message, and checking the type of message, the participant clicks send to send the message.

Another function is to conduct meetings with anyone in the organizational chart in the chain of command. A meeting can be started by selecting the positions to participate in the meeting within the organizational chart, and then clicking on button or other icon to start the meeting. The meeting function may operate like a live chat on the Internet. The person conducting the meeting as well as the participants are identified.

Another function is to check the activity log to see messages sent, meetings conducted, position appointments, and other actions taken. The activity log records all activities that have taken place during the exercise. An ad-hoc reporting feature can generate reports from this recorded information to allow the exercise to be easily critiqued. The ICS (or HICS) forms required to record information are accessible in the control panel for each position. All forms are available for each position, and information can be entered and files saved to record information from the exercise.

The participants also can check the exercise status to determine the progress or the exercise or print out a report. The exercise status screen allows the participants to monitor the progress of the exercise (including, but not limited to, number of positions appointed, exercise time lapsed, number of messages sent, number of messages delivered, number of replies to messages, job action items completed (by position or total), requests for action completed, and percentage progress in the immediate, intermediate and extended response phases; some or all of these may be shown in graph or graphical form), and access the reporting feature to generate standard or custom reports.

Interjections may be sent to each position at several points during the exercise to facilitate actions that should be taken in response to the situation. Exercise controllers and observers can shadow positions during the exercise, and participants can manage more than one IC position at a time. Links may be provided to support websites, and the system may allow more than one organization to use the system.

At the end of the exercise, a message that the exercise has been completed may be sent. Activity logs and summary reports may be obtained, and the participants may meet to evaluate performance.

The invention also may be used to respond to real disasters or other incidents. The personnel responding to the disaster or event will have the advantage of using the same system on which they have been training and on which they have been tested. Additional features may be added to the invention when used as a response system. For example, the messaging component of the system may include the ability to send messages as email and text messaging, and convert text-to-voice so personnel can be called by telephone or cell phone as well.

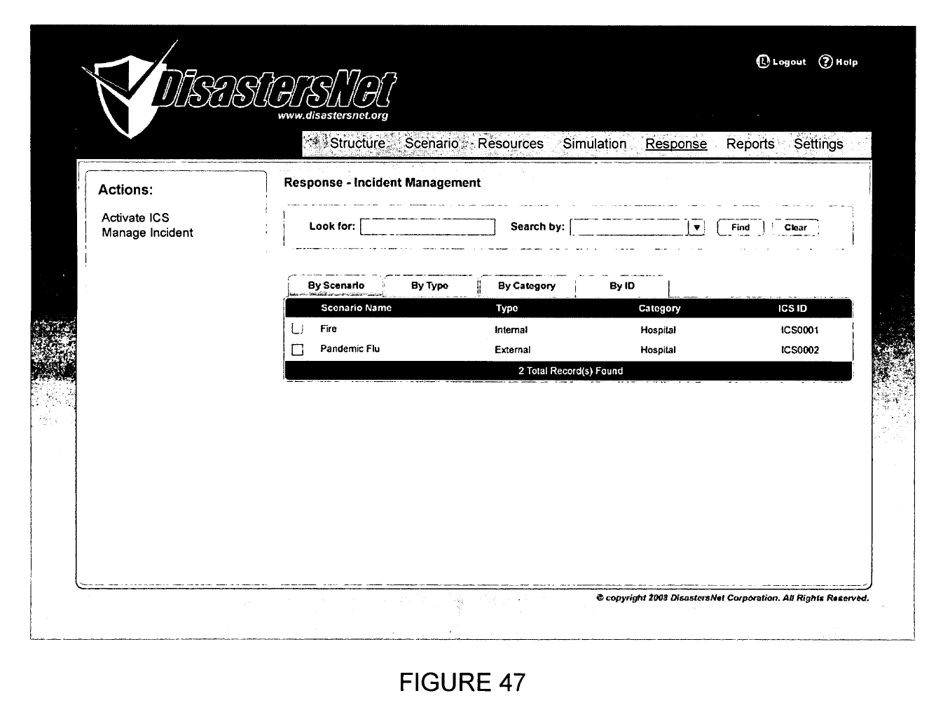

FIG. 47 shows an exemplary embodiment of an incident management screen to be used to activate the ICS system and manage the response to an actual incident. Participant dashboards may be the same as or similar to those described above.

In some exemplary embodiments, feedback from participants, whether in an exercise or an incident event, may be sought.

In one exemplary embodiment, the present invention comprises a series of interconnected modules on a computer-based network, the Internet, or a similar system. One set of modules comprise data entry modules, including but not limited an IC (Incident Command) Team Builder Module (to create IC team positions), a Scenario Builder Module (to create IC team charts that can be activated for specific types of incidents or exercises), and an Exercise Builder Module (to create exercises with multi-media elements and interjections that can be delivered to IC positions, triggered by actions or manually activated by the exercise controller). A Resources Builder Module is used to enter or import resources, assign IC team positions, and communication information; when scenarios are activated, personnel will be notified and provided with a user ID and password that will log into the IC position control panel for their assigned position. A Reports Builder Module is used view and print standard reports (e.g., appointment summary, activity log summary, after action report, time and cost report, and IC team report), as well as build custom reports. A Financial Recovery Module is used to enter cost information associated with an incident, including hourly rates and reimbursement rates for team members, amount of supplies or materials used (including, but not limited to, hospital beds and medical supplies), cost per unit and reimbursement rates, and facility damage repair costs (actual or estimated) and reimbursement rates. A Security Module is used to set user rights to the system. A Links Module is used to link to support sites for access during a response action or exercise.

While the system may be accessed through computers connected, directly or wirelessly, to the Internet or other network, in an alternative embodiment, the system may also allow participation through handheld devices.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

I claim:

1. A incident command system, comprising:
a scenario building module for creating a hazardous incident or crisis scenario;
a resources assignment module for assigning personnel to specific roles in the incident command system for a scenario; and
means for said personnel to take actions in response to the hazardous incident or crisis scenario.

2. The system of claim 1, wherein said actions include sending or receiving communications from other personnel.

3. The system of claim 1, wherein the system operates on a network.

4. The system of claim 1, wherein the system operates on the Internet.

5. The system of claim 1, further comprising a simulation module, said simulation module adapted to conduct a simulation of a hazardous incident or crisis scenario.

6. The system of claim 1, wherein the personnel interact with the system through a computer dashboard interface, said dashboard interface allowing access to an incident command system organizational chart.

7. The system of claim 1, further comprising a reports module.

8. The system of claim 7, wherein the reports module can produce standard or custom reports.

9. The system of claim 8, wherein the standard reports include a time and cost report.

10. The system of claim 1, wherein personnel can view response statistics in real-time.

11. The system of claim 1, wherein said actions include conducting a meeting through a network or the Internet.

12. The system of claim 1, wherein a list of job action sheet items are provided for one or more specific positions.

13. The system of claim 12, wherein job action sheet actions can be time and date stamped when completed.

14. The system of claim 1, wherein said means comprises a computer dashboard interface.

15. The system of claim 1, wherein said means comprises a computer or computing device.

16. The system of claim 15, wherein said device is a handheld computing device.
